(19) United States
(12) Patent Application Publication
(10) Pub. No.: US 2025/0086614 A1
(43) Pub. Date: Mar. 13, 2025

(54) TETHERING FACE IDENTIFIERS TO DIGITAL ACCOUNTS FOR SECURE AUTHENTICATIONS DURING COMPUTING ACTIVITIES

(71) Applicant: PAYPAL, INC., San Jose, CA (US)

(72) Inventors: Amir Eltahan, Singapore (SG); Wei Sun, Singapore (SG); Michael John Aleles, San Marcos, CA (US); Ke Jin, Shanghai (CN); Xinyun Hu, Shanghai (CN); Umang Merwana, Santa Clara, CA (US); Ari Benjamin Van Den Berg, San Jose, CA (US); Gopalakrishnan Srinivasan Ramarajan, Singapore (SG)

(21) Appl. No.: 18/539,115

(22) Filed: Dec. 13, 2023

Related U.S. Application Data
(63) Continuation-in-part of application No. PCT/CN2023/118173, filed on Sep. 12, 2023.

(51) Int. Cl. G06Q 20/36

(52) U.S. Cl. CPC G06Q 20/3674; G06Q 20/3678

(57) ABSTRACT

There are provided systems and methods for tethering face identifiers to digital accounts for secure authentications during computing activities. A service provider, such as an electronic transaction processor for digital transactions, may provide computing services to users, which may be used to engage in interactions with other users and entities including for electronic transaction processing. When utilizing these services, user identity verification may be required to provide secure authentication of users, which may be required to be performed quickly or in real-time for high-risk computing activities. A face identifier of a user may be established and tethered to the user's digital account, which may be used to secure authentication. When establishing, a proof of identity document and facial images of the user may be submitted, which may be processed using face recognition and matching machine learning models. The user's face identifier may then be generated for authentications.

### CROSS-REFERENCE TO RELATED APPLICATION

This application claims priority to and is a continuation-in-part of PCT Patent Application No. PCT/CN2023/118173, filed Sep. 12, 2023, all of which is incorporated herein by reference in its entirety.

### TECHNICAL FIELD

The present application generally relates to user identity authentication and verification and more particularly to utilizing facial identification for secure authentications during computing activities that are at a risk for fraud or abuse.

### BACKGROUND

Service providers may provide computing services to customers, clients, and users through computing systems and services that provide platforms, websites, applications, and interfaces for interactions. Certain computing services and activities may be associated with higher risk of fraud or abuse than other services and activities. For example, cryptocurrency transactions, password reset processes, change of user data or access to personal user or financial data, and the like may be more susceptible to fraud than viewing public content, such as accessing a website to view offerings or data. Before service providers provide certain computing services to users, user authentication and identity verification may be required for proof of identification and current user presence and/or approval to engage in such computing activities. The service providers may provide authentication processes for different computing services and activities, such those designated as “high-risk.” However, conventional authentication mechanisms may be fooled, bypassed, or breached to provide unauthorized access to and use of such computing services, resulting in fraudulent transactions and access to sensitive data.

However, for higher risk activities, such as financial transactions, personally identifiable information (PII) use or access, access or transmission of secure records, data, or digital assets including cryptocurrency, and the like, more secure authentication processes may take longer and may not be provided quickly enough for real-time decisions and fast data processing requirements of computing activities, resulting in failed transactions or processing of fraudulent transactions. This may cause loss for the service provider and lead to fraud and bad user experiences when users' personal data and digital accounts are taken over, fraudulently accessed and used, and the like. These bad user verification experiences may cause users to drop off and give up using service provider computing services and resources. As such, it is desirable to provide more accurate and precise authentications of users in real-time during computing activities and service use.

### BRIEF DESCRIPTION OF THE DRAWINGS

FIG. 1 is a block diagram of a networked system suitable for implementing the processes described herein, according to an embodiment;

FIGS. 2A-2C are block diagrams of networked system components from FIG. 1 for providing a tethered face identifier used to provide improved security during cryptocurrency transactions, according to an embodiment;

FIGS. 3A-3C are exemplary diagrams for determining eligibility for establishing a face identifier that is tethered to a digital account, according to an embodiment;

FIG. 4A-4C are exemplary diagrams for establishing a face identifier that is tethered to a digital account for secure authentications during high-risk computing activities, according to an embodiment;

FIGS. 5A-5C are exemplary diagrams of processing flows for user experiences on different platforms when establishing a tethered face identifier for an account of a user, according to an embodiment;

FIGS. 6A-6D are exemplary screenshots for establishing the face identifier tethered to a digital account for high-risk computing activities and transactions, according to an embodiment;

FIGS. 7A and 7B are flowcharts for tethering face identifiers to digital accounts for secure authentications during computing activities, according to an embodiment; and

FIG. 8 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for tethering face identifiers (IDs) to digital accounts for secure authentications during high-risk computing activities. In further embodiments, the user may also be detected as a user who is engaging in, has a history of, or predicted to engage in high-risk activities, such that a face ID may be required to be established and/or authenticated during request for use of certain computing activities for secure authentication. Systems suitable for practicing methods of the present disclosure are also provided. “High-risk” activities/users, “risky” or “riskier” activities/users, and other similar terms may be identified or determined by systems or users and may vary between systems/users. For example, one system may identify all their activities as high-risk, while another system may only identify a small portion of their activities as high-risk. In another example, one system may identify all users of their services as risky users, while another system may only designate a subset of all their users as risky users. In further examples, risky activities and users may change, such as based on time of year, volume of activities handled by the system during any given period, etc.

In computing systems of service providers, computing services may be used for electronic transaction processing, data or content access, account creation and management, payment and transfer services, customer relationship management (CRM) systems that provide assistance, reporting, sales, and the like, and other online digital interactions. In this regard, computing services and systems may provide computing services to users through various platforms that may require users to verify their identity, authenticate themselves, validate their information, provide supporting documentation for service provision and/or proof of an event, and/or otherwise receive authorizations for computing service use. However, conventional authentication and identity verification processes that are implemented may not provide adequate security for real-time authentications during specific risky or high likelihood of abuse computing tasks, processes, and services, and other more secure mechanisms may take a significant amount of time that is inadequate for real-time decision-making and service request processing. Users may engage in these high-risk computing activities and/or may be high-risk users due to their current or past activities and history. For example, high-risk activities and/or users may be based on user account activities (e.g., transactions, transaction geo-locations, transaction types including cryptocurrency transactions, etc.), which may be associated with a certain risk level and/or score that triggers a requirement for a step-up or heightened authentication, such as through facial recognition and/or identity and document verification.

Thus, when providing these computing services that require secure authentication and/or identity verification, the service provider's system and architecture may implement neural networks (NNs) or other machine learning (ML) models and systems that, when executed by one or more processors and/or engines, provides facial data identification and face ID generation for tethering to a digital account of a user. This may be done by trained NNs and/or ML models for facial feature data identification and extraction in images of users captured for proof of identity (POI) documents, such as user images on such documents (e.g., identity cards, driver's licenses, etc.), as well as in real-time images and/or video captured of a user (e.g., using a mobile device camera and the like). Once the facial ID is generated, it may be linked, or “tethered,” to an account and follow the account when used in computing service provision. Thereafter, real-time identity verification and authentication may be done using this secure and personal data point for facial features and images, which enables secure and real-time authentications in a more efficient and coordinated manner between devices and online platforms, applications, websites, and the like.

For example, authentication and verification may be needed before a service provider provides computing services to users including electronic transaction processing. An online transaction processor (e.g., PayPal®) may allow merchants, users, and other entities to process transactions, provide payments, transfer funds, or otherwise engage in computing services. In other examples, other service providers may also or instead provide computing services for social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and/or financial information.

All of these interactions may request computing service use and operations to process data, perform activities and interactions with other users, which may require authentication and/or identity verification of users, including using images, documents, forms, cards, and the like. In order to provide secure authentication during high-risk computing activities, the service provider may provide an NN or other ML model framework implementing NNs and other ML models, techniques, and algorithms for face and other user image data processing including facial feature detection and other user identification processes for user likenesses (e.g., face, body, biometrics including fingerprints or retinas, etc.). When performing authentications, a tethered ID (TID), such as a face ID from user facial features, may be accessed after previously being established for the user's digital account during a face authentication onboarding process. The TID may then be used for real-time face authentications during the high-risk computing activities using facial images or other images of a user's likeness to provide fast and accurate authentication of the user. For example, the TID may be used to verify and authorize cryptocurrency transactions by a user, a user's account, and/or a user's held or available cryptocurrency (e.g., available on an exchange, with a payment provider, and/or in a hot (online) or cold (offline) digital wallet), as well as with other blockchain uses and functionalities for trading of digital assets (e.g., non-fungible tokens (NFTs) and the like).

In its broadest sense, blockchain refers to a framework that supports a trusted ledger that is stored, maintained, and updated in a distributed manner in a peer-to-peer network. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others the distributed ledger represents each transaction where units of the cryptocurrency are transferred between entities. For example, using a digital currency exchange, a user may buy any value of digital currency or exchange any holdings in digital currencies into worldwide currency or other digital currencies. Each transaction can be verified by the distributed ledger and only verified transactions are added to the ledger. The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger.

Though maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. Cryptocurrency is a medium of exchange that may be created and stored electronically in a blockchain. Bitcoin is one example of cryptocurrency, however there are several other cryptocurrencies. Various encryption techniques may be used for creating the units of cryptocurrency and verifying transactions. As an example, a first user may own 10 units of a cryptocurrency. A blockchain may include a record indicating that the first user owns the 10 units of cryptocurrency. The first user may initiate a transfer of the 10 units of cryptocurrency to a second user via a wallet application executing on a first client device. The wallet application may store and manage a private key of the first user.

In this regard, the wallet application may generate transaction data for transferring the 10 units of cryptocurrency from the first user to the second user. The wallet application may generate a public key for the transaction using the private key of the first user. In order to indicate that the first user is the originator of the transaction, a digital signature may also be generated for the transaction using the private key of the first user. The transaction data may include information, such as a blockchain address of the sender, the digital signature, transaction output information, and the public key of the sender. The transaction data may be broadcasted to the blockchain network such that the transaction may be received by one or more nodes of the blockchain network. Upon receiving the transaction, a node may choose to validate the transaction, for example, based on transaction fees associated with the transaction. If the transaction is not selected for validation by any of the nodes, then the transaction may be placed in a queue and wait to be selected by a node.

Validating the transaction by the node may include determining whether the transaction is legal or conforms to a pre-defined set of rules for that transaction, establishing user authenticity, and establishing transaction data integrity. If the transaction is successfully validated by a node, the validated transaction is added to a block being constructed by that node. Since different nodes may choose to validate different transactions, different nodes may build or assemble a block comprising different validated transactions. Thus, the transaction associated with the first user transferring 10 units of cryptocurrency to the second user may be included in some blocks and not others.

The blockchain network may wait for a block to be published. Validated transactions may be added to the block being assembled by a node until it reaches a minimum size specified by the blockchain. If the blockchain network utilizes a proof of work consensus model, then the nodes may compete for the right to add their respective blocks to the blockchain by solving a complex mathematical puzzle. The node that solves its puzzle first wins the right to publish its block. As compensation, the winning node may be awarded a transaction fee associated with the transaction (e.g., from the wallet of the first user). Alternatively, or in addition, the winning node may be awarded compensation as an amount of cryptocurrency added to an account associated with the winning node from the blockchain network (e.g., “new” units of cryptocurrency entering circulation). This latter method of compensation and releasing new units of cryptocurrency into circulation is sometimes referred to as “mining.”

Thus, a published block may be broadcast to the blockchain network for validation, and, if the block is validated by a majority of the nodes, then the validated block is added to the blockchain. However, if the block is not validated by a majority of the nodes, then the block is discarded and the transactions in the discarded block are returned back to the queue. The transactions in the queue may be selected by one or more nodes for the next block. The node that built the discarded block may build a new next block. If the transaction was added to the blockchain, a server may wait to receive a minimum number of blockchain confirmations for the transaction, and, once received, then the transaction may be executed and assets from the first user may be transferred to the second user. For example, the 10 units of cryptocurrency owned by the first user may be transferred from a financial account of the first user to a financial account of the second user after the transaction receives, for example, at least three confirmations.

In this regard, a service provider may provide an authentication mechanism and process via face recognition and facial image capture, which may utilize intelligent facial recognition models and engines using NNs, ML models, and the like, for cryptocurrency transactions. First a user may be required to be setup for face authentication and verification by establishing a face ID, which may require that the user is eligible for enrollment. One or more face authentication enrollment eligibility checks may be performed, including whether a qualified assurance element is available, and that the user has been sufficiently verified and authenticated. Further, the user may be required to meet certain risk checks and/or not be blacklisted or otherwise have a history of abusive or fraudulent behavior. The user's device and current login or session may be verified and validated, such as through network address checks against known or trusted locations, secure authentications and challenges, and/or identification of valid or risky behaviors and activities. As such, one or more policies may be checked for user approval and verification to enroll in face authentication and TID support for their digital account. If approved, the user may be provided an enrollment page or interface where the user may initially setup a face ID.

When establishing and comparing face images on POI documents and captured from cameras, including during initial onboarding or later face authentication through an established face ID, one or more ML models and/or NNs may be used. To establish a face ID, a user may first be prompted, by the enrollment page or interface, to provide a POI document including user personal information for verification (e.g., driver's license with driver's license number, address, date of birth, height, gender, eye/hair color, etc.), as well as a user image of the user on the document. The user may then be required to take one or more selfies, face images, portraits of the user's face, body, or other likeness, or similar images and/or video.

To confirm the user is present (e.g., not a fraudster holding up an image of the user), one or more tests or challenges may be issued, such as having the user blink, respond to a statement or queue, read text, perform an action, provide personal information or challenge responses either in the image/video or during the image/video capture, and the like. These may correspond to tests to detect and/or determine a “liveness” of the user or other indication that the user is actually present in the images, environment, and/or scene when captured such that the image is not based on another image of the user (e.g., misappropriated images from a user's social media or the like) or other fake representation of the user by another. As such, a confidence score in the user's liveness being present may be determined by the NNs or other ML models, which may be used to determine if the images are valid and approved to be submitted and/or processed for a TID establishment and/or authentication.

The NNs or other ML models may then compare the user image on the POI document to the captured user images to determine a similarity score or threshold, and if sufficiently similar (e.g., meeting or exceeding the similar score or threshold), may generate a face ID for the TID and user's digital account. Generation of the face ID may include determining and/or extracting facial feature data, including features or points of distinction, distance between features, curvature or other shape of features, feature color or other characteristics, and the like. Further, comparison may utilize multiple ML models or NNs for comparing based on mapping face images and features. From face images, vectors may be generated from features and other data points, which may be used for such comparison (e.g., through distance scores and/or similarities, such as Euclidean or cosine similarity) and/or generation and storage of the face ID that is tethered to the user's digital account.

In this regard, the aforementioned comparison processes may be utilized in one or more high-risk or other computing activities of the service provider. For example, the service provider may utilize the TID and face authentication through the face ID to perform real-time identity verification and authentication. The user may capture images of the user's face, such as after a prompt and/or navigation to a page or interface for image capture, where the user may then submit the images for comparison to the user's stored images and/or face ID for authentication. This may be done through a risk challenge and authentication flow experience and server for face authentication, which may utilize the TID and corresponding face ID (e.g., past user images and/or facial feature data or vector extracted or determined from such images). Where the TID has not been setup, setup and requests for a POI document with the user's selfies or other face images may be requested during the high-risk activity. A secure channel may be established between the user's device (e.g., mobile smart phone) and/or device camera and the authentication server for the face authentication, and images may be received for face comparison, matching, and recognition. If approved, a page or interface may be provided to the user, and the user may proceed with the requested activity, processing, data retrieval and/or output, and the like.

In some embodiments, a cryptocurrency transaction flow and user experience may be identified as high-risk and require a corresponding face authentication, for example, as a step-up authentication challenge and process to further validate the user's identity and consent to the cryptocurrency transaction. A user may access a cryptocurrency digital wallet in order to view available cryptocurrency and use, transfer, or pay for items or services with such cryptocurrency. Since access to cryptocurrency, cryptocurrency wallets, and cryptocurrency keys may be a high-risk activity where there is a significant chance of fraud or theft due to the digital nature of cryptocurrency assets and private keys, one or more of these computing activities to access and/or use cryptocurrency may initiate a process for authentication using the TID and face images and/or ID. This process may be initiated by an application or website on request for the cryptocurrency transaction or the like.

As such, when a user requests to transfer, pay with, or otherwise access and use cryptocurrency (including access to and/or movement or transfer of cryptocurrency private keys and the like between different storages or platforms), the user may be required to go through a face authentication challenge using the user's TID. The service provider may similarly provide processes, pages, and/or interfaces for the user to utilize their device to capture and/or submit real-time and/or timestamped images (e.g., captured within a recent time period, such as last 30 seconds), which may be compared to the stored images and/or face ID. Only after proper matching and verification of the user in the image through facial recognition may the cryptocurrency transaction be approved and/or go through.

Further, the TID and face image(s) and/or ID may be used with other cryptocurrency limitations and restrictions, including those associated with access, viewing, downloading or storing, and/or transferring cryptocurrency private keys or other ownership data for cryptocurrency, as well as cryptocurrency trades, exchanges, transfers between different digital wallets, users, and/or online digital cryptocurrency exchanges, and the like. This therefore institutes a heightened security requirement utilizing specific biometrics before high risk of fraud activities are performed. As such, with this secure and intelligent framework, the service provider may facilitate data extraction and verification of secure and trusted IDs. These IDs may be tethered to users' digital accounts to mark the accounts as trusted and valid, as well as authenticated for the user's identity and high-risk computing activities. This may provide a more secure computing environment and processing, which may streamline authentication processes and allow for faster and real-time data processing where step-up and more secure authentication is required. This can improve operational efficiency and effectiveness by ensuring authentications and secure and performed to properly validate user identities. In this manner, the service provider's system for automated image processing may be made more efficient, faster, and require less user inputs and authentication data processing, which may allow for real-time computing activities in high-risk scenarios and computing environments.

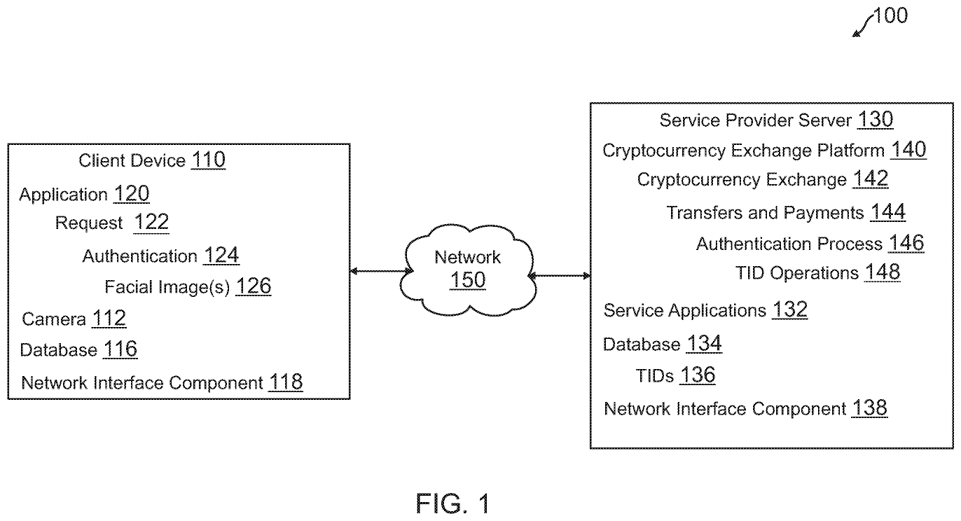

FIG. 1 is a block diagram of a networked system 100 suitable for implementing the processes described herein, according to an embodiment. As shown, system 100 may comprise a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

FIG. 1 provides an overview of system 100 to implement NNs and/or other ML models used for TID creation and use with high-risk computing activities, such as cryptocurrency transactions. Thus, even though FIG. 1 shows specific aspects associated with cryptocurrency, system 100, in other embodiments, is understood to include similar aspects to handle other high-risk computing activities. System 100 may include a client device 110 of a user (not shown) in communication with a service provider server 130 over a network 150. Client device 110 may be utilized by a user, customer, or entity to access a computing service or resource provided by service provider server 130, where the service may provide various data, operations, and other functions to client device 110 via network 150. In this regard, client device 110 may be used to provide facial images and POI documents to establish TIDs through face identification, as well as perform authentication through such TIDs and further facial images. As such, service provider server 130 may analyze and process such images to generate TIDs having associated face identifiers from facial images, POI documents, and the like.

Client device 110 and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device that may utilize appropriate hardware and software configured for wired and/or wireless communication with service provider server 130 and other devices and/or servers. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Client device 110 of FIG. 1 contains an application 120, a camera 112, a database 116, and a network interface component 118. Application 120 may correspond to executable processes, procedures, and/or applications with associated hardware. In other embodiments, client device 110 may include additional or different modules having specialized hardware and/or software as required.

Application 120 may correspond to one or more processes to execute modules and associated devices of client device 110 to provide a convenient interface to permit a user for client device 110 to utilize services of service provider server 130, including computing services that may include providing and submitting images and POI documents for TID establishment with a face ID. Application 120 may further be used for facial image authentication during high-risk computing activities including cryptocurrency transactions. Where service provider server 130 may correspond to an online transaction processor, the computing services may include those to enter, view, and/or process transactions including cryptocurrency transactions, onboard and/or use digital accounts, store, transfer, and/or exchange cryptocurrency including on cryptocurrency exchange platforms and/or with hot/cold digital wallets and the like. To perform high-risk computing activities associated with cryptocurrency transactions, use, and/or transfer, application 120 may provide facial images of a user, which may be captured using camera 112, and/or POI documents, which similarly may be captured using camera 112 or obtained using another source of such documents. As such, the images may be provided when engaging in, as well as before or after and in support of, electronic transaction processing or other computing services associated with digital payment accounts, transactions, payments, and/or transfers.

In this regard, application 120 may correspond to specialized hardware and/or software utilized by client device 110 that may provide transaction processing and other computing service usage through a user interface enabling the user to enter and/or view data, input, interactions, and the like for processing. This may be based on a transaction generated by application 120 using a merchant website or seller interaction, or by performing peer-to-peer transfers and payments with merchants and sellers. Application 120 may be associated with account information, user financial information, and/or transaction histories. However, application 120 may also be associated with cryptocurrency and/or a cryptocurrency digital wallet, which may be stored on device or accessible from another device including a cold offline wallet on another device or server and/or a hot or online digital wallet with an online server system, cloud storage, and/or cryptocurrency trading platform. As such, transactions that are requested may include payments, transfers, and/or sales/acquisitions/trades of cryptocurrency. In further embodiments, different services may be provided via application 120, including messaging, social networking, media posting or sharing, microblogging, data browsing and searching, online shopping, and other services available through service provider server 130. Thus, application 120 may also correspond to different service applications and the like that are associated with service provider server 130.

In this regard, when processing cryptocurrency transactions, these transactions may be designated high-risk and/or otherwise require step up authentication or heightened authentication through use of a face identifier and facial identification/authentication. This may be done using a TID that may be setup and/or used for request 122 for processing. Application 120 may be used to provide facial images and/or POI document images for processing a authentication 124 of a request 122 (or other high-risk transaction request including password recovery, large transactions or large volumes of the same or similar transactions, and the like), where application 120 may capture and transmit facial image(s) 126 to service provider server 130. As such, request 122 may correspond to other types of computing activities where a facial identification is required by service provider server 130 when processing. Facial images 126 may correspond to one or more images captured of a user, which may include video, that may be analyzed for the user's face and liveness or presence in the scene or environment captured in the images or video. Thus, application 120 may include processes to capture, load, and/or provide facial image(s) 126 for processing by service provider server 130, as well as output prompts and/or instructions used to capture a liveness of the user in such images. Application 120 may correspond to a general browser application configured to retrieve, present, and communicate information over the Internet (e.g., utilize resources on the World Wide Web) or a private network. For example, application 120 may provide a web browser, which may send and receive information over network 150, including retrieving website information, presenting the website information to the user, and/or communicating information to the website. However, in other examples, application 120 may include a dedicated software application of service provider server 130 or other entity (e.g., a merchant) resident on client device 110 (e.g., a mobile application on a mobile device) that is displayable by a graphical user interface (GUI) associated with application 120.

Camera 112 corresponds to an optical device of client device 110 enabling a user associated with client device 110 to capture or record images, including still and/or video images. Camera 112 may correspond to a digital camera on client device 110 (e.g., incorporated in client device 110 such as a mobile phone's digital camera in a traditional camera orientation and/or a forward facing camera orientation that captures one or more users as they use and view a display screen of client device 110) or associated with client device 110 (e.g., connected to client device 110 but incorporated within a body or structure of client device 110), or may more generally correspond to any device capable of capturing or recording an image, video, or other digital media data, including infrared imaging or other types imaging devices. As a digital camera, camera 112 may include a sensor array disposed on a semiconductor substrate having a plurality of photosensitive elements configured to detect incoming light. In other embodiments, other types of electromagnetic radiation sensors may be used, including infrared sensitive sensors/elements and the like. In other examples, camera 112 may correspond to a traditional exposure camera, which may include a lens and shudder to allow incoming electromagnetic radiation to be recorded on light sensitive film. In such embodiments, camera 112 may utilize client device 110 to receive recommendations on effects, such as filters, lens, and/or zoom, to apply to incoming light prior to being recorded on photo sensitive film.

Camera 112 may include various features, such as zoom, flash, focus correction, shutter speed controls, or other various features usable to capture one or more images or videos of the user and/or other users or objects. Camera 112 may include other media capture components, including a microphone to capture audio data and/or a touch element or screen that captures a biometric. Camera 112 may further display a preview and/or captured image to the user through another device of client device 110, such as a viewfinder, screen (e.g., mobile phone touch screen, tablet touch screen, and/or personal computer monitor), or other display. Camera 112 may interface with one or more applications of client device 110 to capture media data, such as images/videos, which may be used to determine one or more effects to apply prior to recording media data and/or perform post-processing of recorded media. Camera 112 may also be used to capture media data that is processed to determine reference data points or nodes for use in future facial recognition processes. Image processing application 130 may therefore use camera 112 to capture media data, which may be processed to determine reference media data for facial recognition processes of service provider server 130, or may be processed with reference POI documents, TIDs, and the like to determine an identity of a user.

Client device 110 may further include database 116 stored on a transitory and/or non-transitory memory of client device 110, which may store various applications and data and be utilized during execution of various modules of client device 110. Database 116 may include, for example, IDs such as operating system registry entries, cookies associated with application 120, IDs associated with hardware of client device 110, or other appropriate IDs, such as IDs used for payment/user/device authentication or identification, which may be communicated as identifying the user/client device 110 to service provider server 130.

Client device 110 includes at least one network interface component 118 adapted to communicate with other computing devices, servers, and/or service provider server 130. In various examples, network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 130 may be maintained, for example, by an online service provider, which may provide computing services, including electronic transaction processing for cryptocurrency and management of other high-risk transactions and computing activities, via network 150. In this regard, service provider server 130 includes one or more processing applications which may be configured to interact with client device 110 to provide data, user interfaces, platforms, operations, and the like for the computing services to client device 110, as well as facilitate improved and enhanced digital security and authentication through TIDs for accounts that use face IDs and facial recognition. In one example, service provider server 130 may be provided by PAYPAL®, Inc. of San Jose, CA, USA. However, in other examples, service provider server 130 may be maintained by or include another type of service provider.

Service provider server 130 of FIG. 1 includes a cryptocurrency exchange platform 140, service applications 132, a database 134, and a network interface component 138. Cryptocurrency exchange platform 140 and service applications 132 may correspond to executable processes, procedures, and/or applications with associated hardware. In other embodiments, service provider server 130 may include additional or different modules having specialized hardware and/or software as required.

Cryptocurrency exchange platform 140 may correspond to one or more processes to execute modules and associated specialized hardware of service provider server 130 to provide a platform for cryptocurrency transactions including payments, transfers, ownership exchanges, currency exchanges and/or trades, acquisitions and sales, and the like, which may be designated as high-risk due to the potential for theft and misappropriation of cryptocurrency with the difficulty of recovery of such digital assets. In this regard, cryptocurrency exchange platform 140 may correspond to specialized hardware and/or software used by service provider server 130 to process cryptocurrency transactions, as well as require authentication including facial recognition and/or face ID authentication. As such, cryptocurrency exchange platform 140 may provide processes for establishing and utilizing a TID that includes a face ID allowing for authentication through capture of facial images. In some embodiments, cryptocurrency exchange platform 140 and/or cryptocurrency exchange 142 may reside outside of service provider server 130, such as third party and/or external partner services and platforms for the exchange of cryptocurrency and/or conducting and processing of high-risk transactions. As such, the processed for TID authentication through face identifiers and the like may be provided as a service (e.g., ID as a service (IDaaS) provision, such as an identity assurance service or IDAS of service provider server 130) to other platforms, cryptocurrency or other asset and/or financial security exchange, and the like.

In this regard, cryptocurrency exchange platform 140 may provide a cryptocurrency exchange 142 where cryptocurrency may be bought, sold, and/or exchanged for fiat, other cryptocurrency, digital assets (including nonfungible tokens (NFTs)), and the like. Cryptocurrency exchange 142 may provide a hot or online digital wallet for cryptocurrency exchanges and may also provide and/or allow access to cryptocurrency of one or more other users to other applications and wallets, including a transaction processing application of service applications 132 in order to buy and sell goods, services, products, and other items using cryptocurrency. In this regard, cryptocurrency exchange 142 may provide transfers and payments 144, which may correspond to one or more operations and/or computing processes to request, processes, and complete cryptocurrency transactions. To do so, authentication processes 146 may be implemented, which may include standard authentication (e.g., name, username, emails, etc., with a secret such as a password, PIN, biometrics, etc.), multifactor authentication, CAPTCHA or other machine/human tests, and the like. However, when using transfers and payments 144, due to the digital nature of cryptocurrency and transferability using private keys without requiring physical assets, user identity verification, and the like, transfers and payments 144 may be at high-risk of fraud, abuse, and/or exploitation.

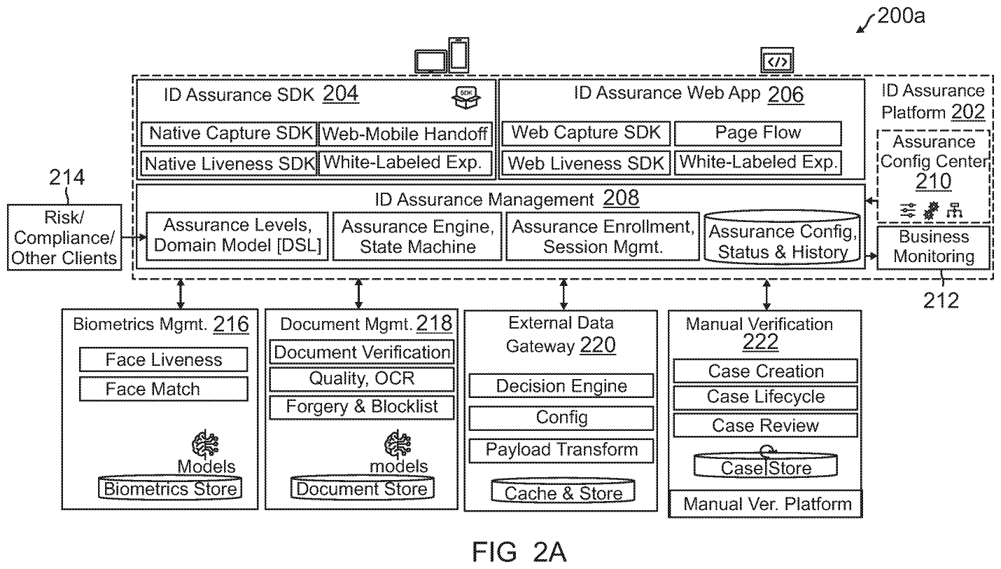

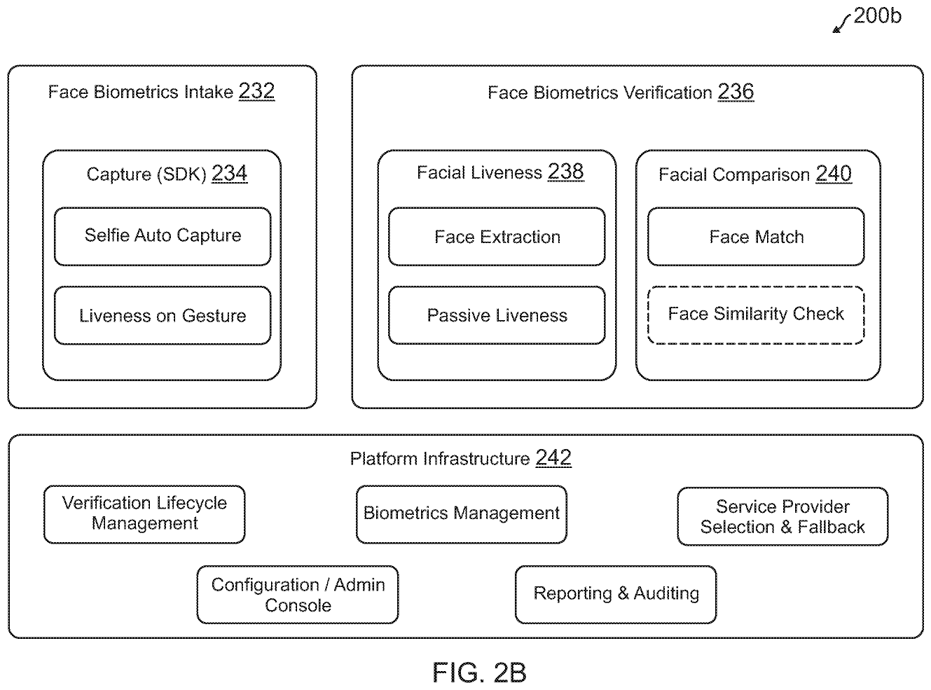

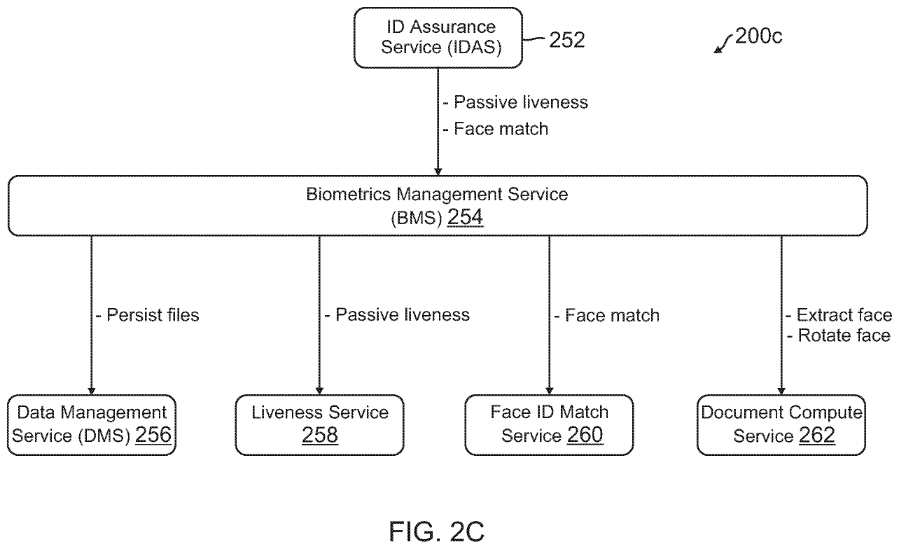

As such, authentication processes 146 may implement a more secure authentication feature for accounts performing cryptocurrency transactions, which may include use of a TID. A TID may be established by creating a face ID for a user and the user's account, which is then tethered to the account and accompanies the account during account usage. As such, verification of the TID may be required for particular processes, such as those designated as high-risk computing activities for fraud, abuse, or exploitation. The TID may be created using TID operations 148 by the user submitting one or more facial images that have a requisite liveness as verified through a confidence score (e.g., sufficient score of confidence, such as by meeting or exceeding a threshold score, that the user is in the image), as well as one or more POI documents having the user's image for user identification verification and identity information submission. TID operations 148 may include one or more operations to verify the user is present in the submitted selfies or other facial images and corresponds to the user's image(s) on the POI document(s). A face ID may be established and linked to the account as a TID. Thereafter, TID operations 148 may be used to verify a user is present and identified for high-risk computing activities when a facial image is requested and submitted to proceed with an authentication. As such, TID operations 148 may include one or more NNs, ML models, and/or other AI models and systems that may perform facial recognition and/or facial image processing for identity verification. The further operations to establish and use a TID are discussed in further detail with regard to FIGS. 2A-7 below.

As such, in various embodiments, cryptocurrency exchange platform 140 includes NNs and ML models that may be used for intelligent decision-making and/or predictive outputs and services, such as during the course of processing image submissions for facial image processing, face ID generation, and/or facial recognition. Thus, ML models may provide a predictive output, such as a score, likelihood, probability, or decision, associated with assessment of whether a user is present in an image (e.g., liveness of a user), whether different images include the same user, and whether a later captured image is that of a user (e.g., to authenticate the user). NNs and ML models may include different NNs and ML model algorithms, such as deep NNs, ML algorithms, and other techniques for facial recognition and classification. Although NN algorithms are discussed herein, it is understood other types of NNs, ML models, and AI-driven engines and corresponding algorithms may also be used.

For example, cryptocurrency exchange platform 140 may include NNs trained for intelligent decision-making and/or predictive outputs (e.g., scoring, comparisons, predictions, decisions, classifications, and the like) for particular uses with computing services provided by service provider server 130 for user facial image authentication and verification. TID operations 148 may include and/or utilize AI models, such as ML or neural network (NN) models. AI models may generally correspond to any artificial intelligence that performs decision-making, such as rules-based engines and the like. However, AI models may also include subcategories, including ML models and NN models that instead provide intelligent decision-making using algorithmic relationships. Generally, NN may include deep learning models and the like, and may correspond to a subset of ML models that attempt to mimic human thinking by utilizing an assortment of different algorithms to model data through different graphs of neurons, where neurons include nodes of data representations based on the algorithms that may be interconnected with different nodes. ML models may similarly utilize one or more of these mathematical models, and similarly generate layers and connected nodes between layers in a similar manner to neurons of NN models.

When building ML models, training data may be used to generate one or more classifiers and provide recommendations, predictions, or other outputs based on those classifications and an ML model. The training data may be used to determine input features for training predictive scores or outputs, which may be used to generate a decision, classification, rule execution, or the like associated with coding, generating, and/or updating of a pluggable module. This may allow for training of ML model associations, clusters, and/or layers. For example, NN and/or other ML models may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models that attempt to classify or identify a webpage resource, next state for a crawling operation or webpage, and the like. By providing training data to train ML models, the nodes in the hidden layer may be trained (adjusted) such that an optimal output (e.g., a classification) is produced in the output layer based on the training data. By continuously providing different sets of training data and penalizing ML models when the output of ML models is incorrect, ML models (and specifically, the representations of the nodes in the hidden layer) may be trained (adjusted) to improve its performance in data classification. Adjusting ML models may include adjusting the weights associated with each node in the hidden layer. Thus, when ML models are used to perform a predictive analysis and output, the input may provide a corresponding output based on the classifications trained for ML models.

In some embodiments, during face authentication using established face IDs, a user may transmit an identification request that may be processed using TID operations 148. The request may include user information and at least an image or user selfie. Using secure retrieval and data processing, an identifying photo or other data for the TID may be retrieved and used to verify an identity of the user using TID operations 148. In one embodiment, the received image and the retrieved identifying image or other data for the TID are both input to individual ML models used by TID operations 148. In other words, the TID is input to a first machine learning model A and the same TID is input to the second machine learning model B. Simultaneously, the received image is input as a user image into the models. Model A may then take the TID and user image and process the information accordingly such that a first feature vector is obtained and used in determining a corresponding first distance score. Similarly, model B may take the user image and TID and process the information accordingly such that a second feature vector and a corresponding distance score is obtained. Note that in some embodiments, a single input may exist for both the TID and user image for both model A and model B.

Model A and model B may be distinct models which use two distinct feature vectors of distinct size. In one exemplary example, model A can include a model used to map the face images to a distance and determine similarity based on the distance. In another exemplary example, model B can include a model that includes deep learning with the use probabilities for determining a similarity. Accordingly, the two models can include feature vectors which are distinct. In one embodiment, for example, the first model A can include a vector of 128-dimension features while the second model B can include a vector of 512-dimension features.

Based on the feature vectors, a distance score may be computed, which may entail the similarity between the features. Thus, each computation may include a different threshold considered in determining a similarity (between TID and the user image) and thus a predicted match. In one embodiment, model A may include a first threshold value and model B may include a second threshold value greater than the first threshold value. In addition, in computing the distance score, various methods may be used. For example, an absolute value norm, Euclidean distance, L-norm, and the like may be used. In one embodiment, an L-2 distance may be used for distance measurement and normalization. Then, once distances are computed, the parallel data modeling is ensembled to provide a single ensemble score that may be compared against an identification threshold that will allow the system to make a final prediction (e.g., a prediction result) regarding the claimed identity. In one embodiment, the threshold may be selected as an average of the distance scores and/or some adjustment. Alternatively, the threshold may be a predetermined value that is tuned for the analysis at hand. Note that the threshold values may be determined offline and during the training process which may be optimized based on an analysis of the false/true positives. Therefore, instead of a single distance score, an ensemble score may be obtained as a result of the two (normalized) distance scores obtained during the parallel processing. Consequently, the prediction result can result in an indication as to whether a successful match exists (or not) with regards to a match to the claimed identity.

Note that presented herein is an exemplary parallel processing model used for face identification. The model however is not so restricted and can include more or less modules for performing the data analytics. For example, some modules may be included and used for face alignment where the selfie or received image includes a background that may be cropped, and face aligned and centered. In another example, additional modules may be included and used for preprocessing of the received image. This may be done in instances where the received image includes a user that is not looking forward directly at the camera or otherwise looking away from the camera, which may require processing before the face identification analytics may be performed. Still in another example, other modules may be included to help alleviate low-resolution. Thus, processing of the received image may occur that will enhance the resolution and improve the overall identification performance.

In addition, the models presented here stem from convolutional neural networks (CNN) for use with image processing, however other models may be used including but not limited to artificial neural networks, structured prediction, clustering, dimensionality reduction, etc. Further, the models may both be CNN models, mix of CNN and other model, or any combination thereof. In addition, further to the use of threshold values for making a decision, other decision methods may be applicable. For example, ranking may be used for making a decision.

As indicated, parallel processing introduced herein enables the use of two distinct models for making a face identification. Model A and model B used by TID operations 148 are described to include an exemplary process for how the final prediction is achieved. Because image processing is considered here, nearby pixels may be strongly related and as such deep learning is often required. In one embodiment, two distinct CNN models are used and executed for use in the face identification.

In further embodiments, a first model is introduced which may be used in conjunction TID operations 148 for the parallel processing in the image identification. The first model may include a convolution neural network model as maybe required for its deep learning capabilities and techniques often optimal in image recognition. In the first model, a simplified version is expressed wherein the batch information or images are input to the model architecture. The model architecture can include a CNN model A which may be used for performing the matching involved between the received image and the claimed identity. Upon completion of the processing by the model architecture, the model information may be normalized. As is understood, magnitude and length of vectors are often required when using machine learning algorithms. In one embodiment, an L2 norm may be calculated and used in calculating the vector magnitudes/lengths commonly referred to as vector norms in the normalization process. In other embodiments, L1 norm, max norm, and other normalization techniques may be used. After normalization, face embedding (not shown) may occur. Face embedding may include the analyzing and return of numerical vectors representing the detection of the facial image in a vector space. In one embodiment, model A may include a first set of feature vectors (e.g., 128-dimension features). The first model may then conclude with training (e.g., triplet loss) which may be the comparison of a baseline value with a negative input. As indicated in parallel modeling, the model can then provide a distance score which may be used in conjunction with the second model B for computing the ensemble score.

Further, a second exemplary model may also be a CNN model for its deep learning capabilities and ability to provide superior face recognition results. The CNN model (e.g., SphereFace) much like the first model may also include the input data (e.g., images) and various computational modules, for example, training of embedded layers and feature vectors. Thus, the second model may entail the convolutional architecture where training may also occur and the fully connected layers where embedding and feature vector with a varying dimension (e.g., 512) over the first mode may exist. Thus, at the second model is training that occurs in association with the model, wherein in addition to the layers, the labels are also determined for the given face. In addition, optimization schemes may also be added and used to determine a more stable gradient using probabilities such that the labels may be identified. Then during the identification process, the features vector (of predetermined dimension) may be used and metrics determined.

TID operations 148 may provide the ability to identify and verify a claimed identity. First, a request for a face identification is received. As previously indicated, TID operations 148 include the receipt of a request and received image from client device 110 associated with the person requesting access and/or identification. The request may include an input and image capture from client device 110. In most instances, the image capture may derive from a camera on client device 110. In other instances, the image may derive from a video, one or more still images or short capture images, and the like, and may originate from a device which is capable of transmitting and communicating with TID operations 148. With the request for verification, additional user information may also be transmitted enabling the retrieval of a claimed identity or retrieved image. Therefore, the claimed user information is obtained and used to retrieve one or more images or other data for a TID (e.g., a vector or other encoding from past images of the user) stored in the secure database and/or associated galleries.

Image pre-processing may occur. The pre-processing may include cropping and aligning of the received image. For example, in the instance that the received image is not aligned, at receipt, the image may be pre-processed to align and enable adequate facial detection and verification. Similarly, in another example, in the instance where the image includes a background or is received where the user is at an angle, further pre-processing may also occur to enhance the received image and consequently the facial detection. Still in another example, the received image may be pre-processed if the image resolution is poor or low and resolution pre-processing may be used to improve the image resolution and overall system performance.

Next, as pre-processing is completed, the process continues to the facial recognition models. As indicated above, TID operations 148 includes an ensemble parallel processing wherein two or more distinct models are used for the facial identification. As such, the received image is matched against the claimed identity. The two models used may be convolutional neural network models which use a combination of feature vectors, distance computations, and normalization for a first determination (e.g., score) for the received image. Thus, a first determination is made on whether a match exists between the claimed identity and the received image using the first model (e.g., model A). Similarly, and in parallel, a second determination is made on whether a match exists between the claimed identity and the received image using the second model (e.g., model B).

The determinations or scores may then be jointly used to obtain an ensemble score. In one embodiment, the ensemble score may be an average score. In other embodiments, the ensemble score may be a dynamically adjusted score determined at least in part from the models, features, and other normalization parameters. The score may then be used to make a prediction regarding the facial identification. The prediction result is made as an outcome of the comparison between the ensemble score and a threshold value. Therefore, if the prediction is that indeed a match exists between the received image and the claimed identity, a response to the validation request or image received may be transmitted using TID operations 148 to client device 110. In this instance, a successful access or message may be transmitted to client device 110 associated with the user of the received image. Alternatively, if the validation system determines that the prediction determined that a match does not exist, then a failure notification or access request failure may be transmitted to client device 110.

Service applications 132 may correspond to one or more processes to execute modules and associated specialized hardware of service provider server 130 to process a transaction or provide another service to customers or end users of service provider server 130. For example, service applications 132 may include a transaction processing application and may correspond to specialized hardware and/or software used by service provider server 130 to provide computing services to users, which may include electronic transaction processing and/or other computing services provided by service provider server 130, such as in response to receiving transaction data for electronic processing of transactions initiated using digital wallets. In some examples, service applications 132 may be used by users, such as a user associated with client device 110, to establish user and/or payment accounts, as well as digital wallets, which may be used to process transactions. Accounts may be accessed and/or used through one or more instances of a web browser application and/or dedicated software application executed by client device 110 and engage in computing services provided by service applications 132.

Financial information may be stored to the account, such as account/card numbers and information. A digital token for the account/wallet may be used to send and process payments, for example, through an interface provided by service applications 132. The payment account may be accessed and/or used through a browser application and/or dedicated payment application executed by client device 110 and engage in transaction processing through service applications 132. Service applications 132 may process the payment and may provide a transaction history to client device 110 for transaction authorization, approval, or denial. In other examples, service applications 132 may instead provide different computing services, including social networking, microblogging, media sharing, messaging, business and consumer platforms, etc. Such services may be utilized through user accounts, websites, software applications, and other interaction sources, which may include cryptocurrency transactions and/or use or transfer of cryptocurrency that may be validated using TID operations 148 and a TID of a user.

Service applications 132 may also provide additional features to service provider server 130 and/or client device 110. For example, service applications 132 may include security applications for implementing server-side security features, programmatic client applications for interfacing with appropriate application programming interfaces (APIs) over network 150, or other types of applications. Service applications 132 may contain software programs, executable by a processor, including one or more GUIs and the like, configured to provide an interface to the user when accessing service provider server 130, where the user or other users may interact with the GUI to more easily view and communicate information. In various examples, service applications 132 may include additional connection and/or communication applications, which may be utilized to communicate information to over network 150.

Additionally, service provider server 130 includes database 134. Database 134 may store various IDs associated with client device 110. Database 134 may also store account data, including payment instruments and authentication credentials, as well as transaction processing histories and data for processed transactions. Database 134 may store financial information and tokenization data, as well as transactions, transaction results, and other data generated and stored by service applications 132. Further, database 134 may store TIDs 126 for different users of service provider server 130 to provide enhanced authentication and user identity verification during high-risk computing activities, such as cryptocurrency transactions that may be validated by TID operations 148. As such, TIDs 126 may include and/or correspond to past user images that have been verified, POI documents used to validate user information and/or the past user images, and/or encoded features or vectors from such images that may be used for further authentications when a user image, such as a facial image, is captured to authentication a user for a cryptocurrency transaction or other high-risk computing activity.

Service provider server 130 may include at least one network interface component 138 adapted to communicate with client device 110 and/or other computing devices and servers directly and/or over network 150. Network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIGS. 2A-2C are block diagrams 200a-200c of networked system components from FIG. 1 for providing a tethered face identifier used to provide improved security during high risk transactions, such as cryptocurrency transactions, according to an embodiment. Diagram 200a of FIG. 2A includes components of a framework and orchestration layer for TID authentication through face IDs and facial images, such as components used by cryptocurrency exchange platform 140 of service provider server 130 from system 100 of FIG. 1. In this regard, an ID assurance platform 202 may act as an orchestration layer that orchestrates establishment and/or use of TIDs between different platforms, components, and services of a service provider, such as cryptocurrency exchange 142 and/or service applications 132 of service provider server 130 in system 100.

In diagram 200a, ID assurance platform 202 includes an ID assurance software development kit (SDK) 204 and an ID assurance web application 206 that may be used to provide TID operations on various platforms, such as mobile device applications and/or websites and web applications, respectively. Further, ID assurance platform 202 includes an ID assurance management 208 to manage TID establishment and authentications, which may interact with an assurance configuration center 210 to receive configurations for TID establishment and use, as well as provide results from various TID operations and/or authentications to business monitoring 212 for reporting.

ID assurance SDK 204 may provide an SDK, code packages, code snippets, API configurations and/or specifications, and the like that may allow for developers and/or other entities providing software applications to setup and use TIDs through their corresponding applications. For example, the operations provided by ID assurance SDK 204 may include those for image capture of a user's face or other likeness, detection of liveness in the captured scene or environment and/or prompts to perform actions indicating a user's liveness in images, capture of POI documents, and the like, which may include guides, prompts, centering or image correcting operations, and the like for image capture. For example, ID assurance SDK 204 may include a native capture SDK and a native liveness SDK. ID assurance SDK 204 may further include interfaces, processing flows through interfaces and operations to capture images and create a TID or authenticate using a preexisting or newly created TID, and the like, which may be used to exchange data with a server. As such, ID assurance SDK may include a web-mobile handoff to exchange data and a white-labeled experience for a user experience with TID establishment and/or use for authentication. In a similar manner, ID assurance web application 206 may include web-based SDKs and features for implementing a web application and/or website features for TID use, including a web capture SDK, web liveness SDK, page flow for webpage navigations and transitions, and a white-labeled experience for a web-based user experience.

As such, different providers and entities may implement TID features provided by ID assurance SDK 204 and/or ID assurance web app 206, and TID establishment or authentication requests may be received from service clients 214, such as a risk service client, a compliance service client, or the like. Service clients 214 may correspond to the clients of different computing services that require or use TIDs for user authentication through facial images during certain computing activities, such as high-risk activities and those designated for TID use. ID assurance management 208 may interface with service clients 214 to perform such TID functions and processing operations. ID assurance management 208 may therefore act as an orchestration layer to orchestrate use of TIDs through the various computing services requesting TID services (e.g., for secure authentications using face IDs) for service clients 214. To perform these functions, ID assurance management 208 may include assurance levels for a domain model indicating the different assurances required by different services in a domain, an assurance engine to provide TID assurances or authentications, an assurance enrollment to enroll in TID use by a user, and an assurance configuration that configures ID assurance management from assurance configuration center 210 and provides data reported to business monitoring 212.

Further, ID assurance management 208 may interact with various internal and/or external components and systems, including those of the service provider and/or third-party entities and vendors. For example, a biometric management 216 may correspond to an API gateway that may analyze face liveliness and face matching, which may be used with a document management server 218 for managing and verifying POI documents, as well as data extraction (e.g., using OCR, object detection, face identification, forgery identification, etc.) of data on such documents. An external gateway 220 may connect to various services for ML models and/or NNs, which may make decisions on face identification, authentication, and matching. However, a manual verification 202 may provide processes and components that allow for manual verifications when needed (e.g., case-by-case).

Referring now to diagram 200b of FIG. 2B, components of a face biometric verification and authentication system and/or platform, such as the authentication processes provided by ID assurance platform 202 in diagram 200a, are shown. For example, in diagram 200b, the platform may include a face biometrics intake 232 having a capture SDK component 234, a face biometrics verification 236 having a facial liveness component 238 and a facial comparison component 240, and a platform infrastructure 242. For face biometrics intake 232, capture SDK component 234 may provide processes for capture of facial images and/or POI documents, which may include a selfie auto capture process and a liveness on gesture process. Capture SDK component 234 may therefore be used as intake of facial images and/or other face biometrics for processing by face biometrics verification 236.

In this regard, face biometrics verification 236 utilizes facial liveness 238 to determine if a user is actually present when an image of the user's face or other likeness occurs (e.g., that the image of the user is not copied, created from another image of the user, previously captured or downloaded and being used by another entity that is not the user, etc.). For example, facial liveness 238 includes a face extraction and a passive liveness, which may be used to detect facial features and/or signs that the user is present, which may correspond to motions with the user's head or facial features, blinking, performing an action (e.g., winking, smiling, turning their head in a direction, or other instructed action). To perform face authentication, facial comparison 240 may perform a face match and a face similarity check, which may utilize vectors generated from facial features and other image data to compare differences between faces in facial images and/or face IDs for the user's TID. This may allow for a degree of error or difference in similarity, such as based on an amount of time between images (e.g., aging, changing hairstyle or facial hair, glasses, etc.). In order to provide these services, platform infrastructure 242 may provide different components including a verification lifecycle management to manage TIDs over a lifecycle of changing images and use, biometrics management of face biometrics, service provider selection and fallback for computing service uses and fallback options when unavailable, a configuration including an administrator console for platform configuration, and/or a reporting and auditing of TID use and authentication for proper compliance and security.

Referring now to FIG. 2C, diagram 200c shows the face biometric platform in diagrams 200a and 200b, such as ID assurance platform 202, implemented as an orchestration layer configured to provide TIDs and identification/authentication through TIDs as a computing service to various clients, applications, computing services, and the like of a service provider. In this regard, diagram 200c shows an orchestration layer and service that orchestrates authentication through TIDs. An ID as a service (IDAS) component, such as a server 252, may provide input to a biometric management service (BMS) 254 that may manage face biometrics and authentication through TIDs. server 252 may act as a service endpoint and/or component that provides ID services through TIDS to different applications, platforms, and services.

BMS 254 may interact with a data management service (DMS) 256 to manage data, including persisting files for images and/or image data used for TIDs. DMS 256 may therefore store files for facial images and/or POI documents. A liveness service 258 may provide a passive (as well as active, where prompts may be requested in real-time) liveness check to identify whether a user is present in images. Once verified by liveness services 258, a face ID match service 260 may perform face ID matching to facial images captured for authentication. For POI documents, a document compute service 262 may provide processes to extract a face and/or rotate as needed from facial images on POI documents. As such, BMS 254 may verify and persist face matching and recognition of facial images and data between captured images, POI documents, and/or previously provided face images or identifiers. This may be based on a face match and passive liveness of the face in the images, as well as extracting face data and features.

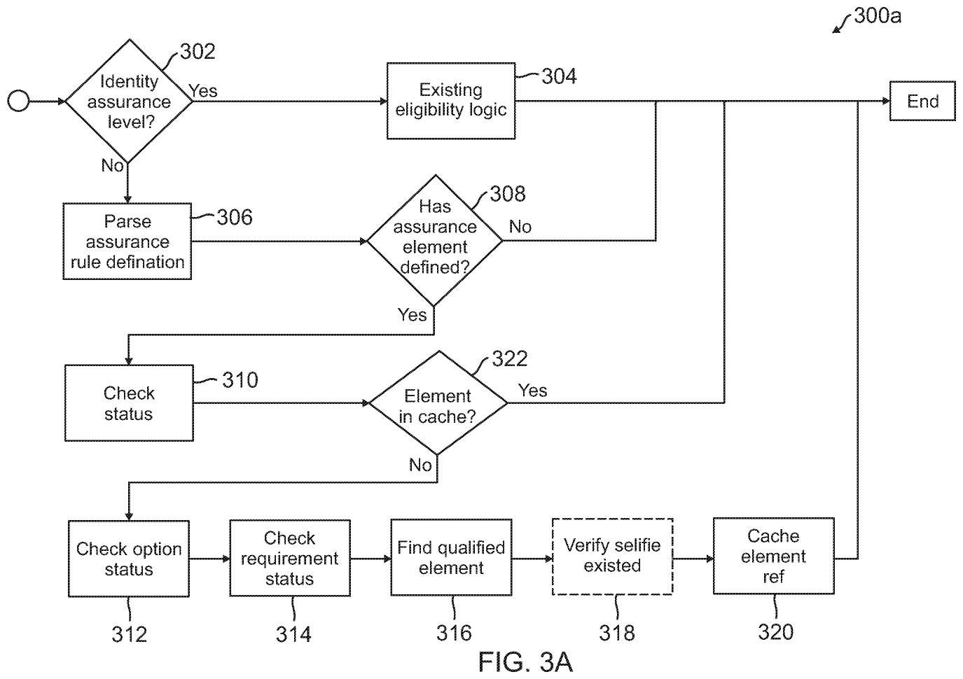

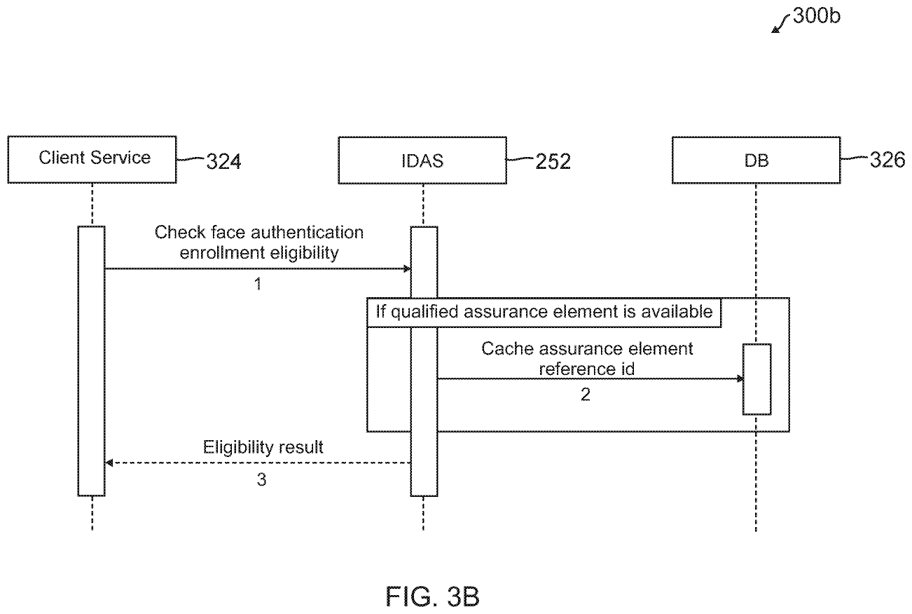

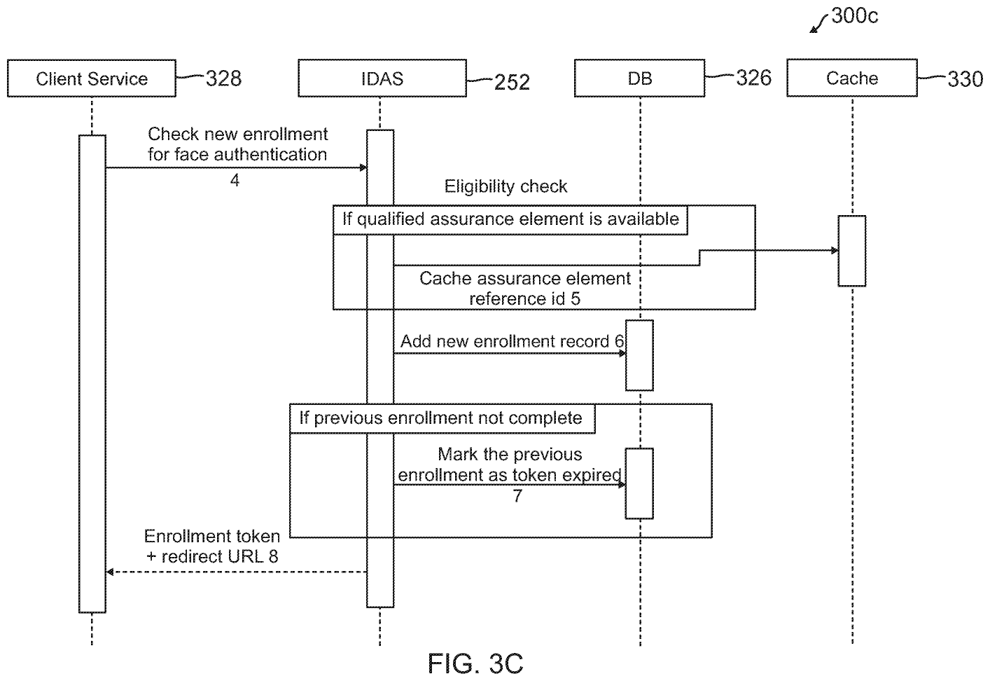

FIGS. 3A-3C are exemplary diagrams 300a-300c for determining eligibility for establishing a face identifier that is tethered to a digital account, according to an embodiment. Diagrams 300a-300d include exemplary processing flows utilized a service provider, such as service provider server 130 discussed in reference to system 100 of FIG. 1, to determine eligibility for TID enrollment. In this regard, service provider server 130 may receive a request for TID enrollment from a device of a user prior to or during a cryptocurrency transaction or other high-risk computing activity, and determine whether the user and/or the user's account is eligible using the processing flows in diagrams 300a-300d.

Referring now to diagram 300a of FIG. 3A, an identity assurance level is analyzed to determine if a user is eligible for TID enrollment. At step 302, it is determined if an identity assurance level (IAL) exists. If yes, at step 304, existing IAL eligibility logic is used and the process in diagram 300a may end, where such logic is used to make a decision on whether to provide TID enrollment based on the existing IAL eligibility logic and the IAL for the user. However, if no IAL exists at step 304, diagram 300a proceeds to step 306 where assurance rule definitions are parsed to determine whether an assurance element may be defined for the user, and therefore a corresponding IAL may be set for the user based on the rule definitions. At step 308, it is determined if the assurance element is defined from the parsed rules. If not, the process in diagram 300a may end where an assurance level has not been defined and required creation, thereby requiring further data prior to determining an IAL for the user and determination of enrollment for a TID.

However, if an assurance element from the assurance rules is defined, an IAL status is then checked at step 310, based on the assurance element that was defined. If an element reference or the like is cached, at step 312, the process in diagram 300b may end with the IAL from the status check found at step 310 and cached at step 312. If the element reference is not cached at step 312, at step 314, an option status for the TID is checked for whether the option may be provided to the user for TID enrollment. Further, a requirement status for TID requirements for enrollment by the user is checked, at step 316. A qualified assurance element is then found at step 318, which allows an optional step 320 to be performed to verify whether a selfie or other facial image of the user exists or existed in a database, such as BMS 254. This element reference is then cached at step 322, after which the process in diagram 300a may end for TID enrollment.

Referring now to diagram 300b of FIG. 3B, a client service 324 may interact with IDAS 252 and a database 26 to check and provide an eligibility result for TID enrollment. This may be performed through API calls between the corresponding components in diagram 300b. Initially, client service 324 may check IDAS 252 for a face authentication enrollment eligibility, at step 1. This may correspond to an API call to IDAS 252 for an API response to TID enrollment eligibility for face authentication using a face ID and/or facial images. Using the process in diagram 300a, IDAS 252 may then perform a database lookup and/or query for a qualified assurance element, and at step 2, caches the assurance element reference ID if such element is available to database 326. Once cached, at step 3, IDAS 252 then provides an eligibility result to client service 324 based on the assurance element reference ID.

Referring now to diagram 300c of FIG. 3C, a client service 328 may interact with IDAS 252 in order to create a new enrollment for a user for a face authentication using a created TID and face ID for the user. In this regard, at step 4, client service 328 creates this new enrollment through an API call to IDAS 252. IDAS 252 performs an eligibility check from database 326 and if the qualified assurance element is available in database 326, caches the assurance element reference ID in a cache 330. After caching the assurance element reference ID, at step 6, IDAS 252 adds a new enrollment record for the user to database 326. In order to have only a single enrollment pending for completion, at step 7, if a previous enrollment has not been completed, the previous enrollment is marked as “token expired” such that a previous enrollment token may be designated as expired an unable to be used to TID and face authentication enrollment. At step 8, an enrollment token and redirect URL for a TID sign up and enrollment page is provided back to client service 328 for use in enrolling the user with the face authentication and TID establishment. Thereafter, payment application 332 may be provided with a TID link to enable enrollment for the TID and face authentication via payment application 332.

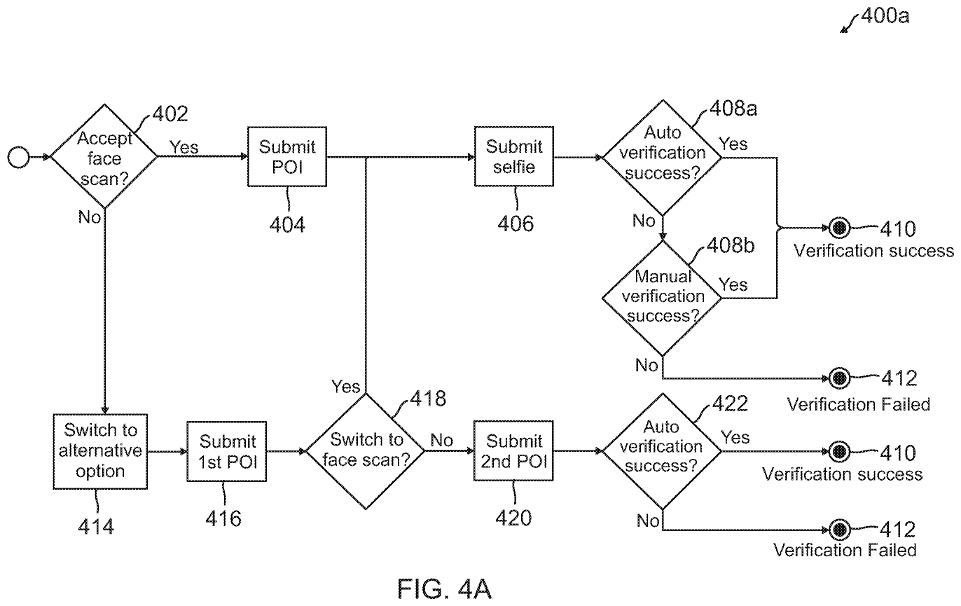

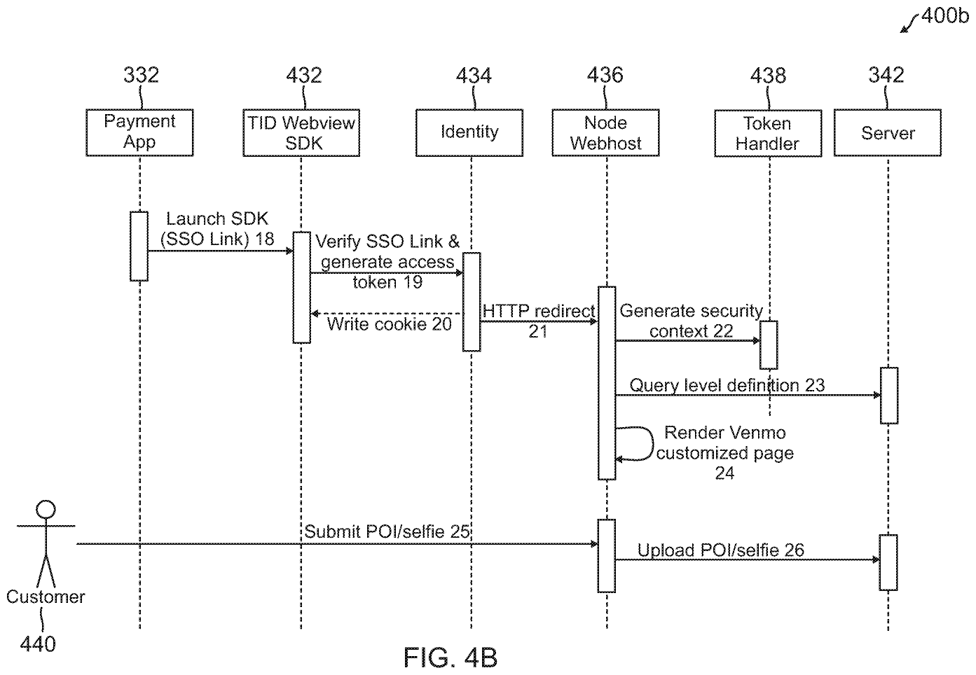

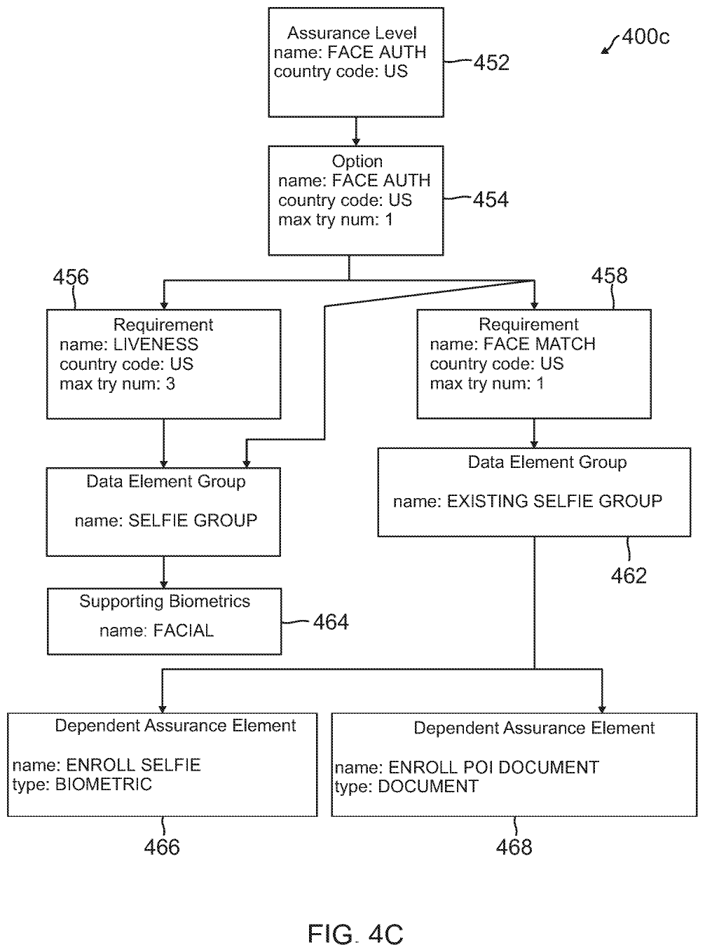

FIG. 4A-4C are exemplary diagrams 400a-400c for establishing a face identifier that is tethered to a digital account for secure authentications during high-risk computing activities, according to an embodiment. Diagrams 400a-400d include processes and components for enrollment and use of a TID for face authentication during high-risk computing activities, including cryptocurrency transactions, password recoveries, and the like, using a face ID, such as processes and components used by cryptocurrency exchange platform 140 of service provider server 130 from system 100 of FIG. 1.

In diagram 400a of FIG. 4A, at step 402, it is determined if a face scan is accepted for use during an enrollment in face authentication for a TID, which may be used for high-risk computing activities and transactions including cryptocurrency transactions, password recovery, and the like. Face scan may be accepted when a user's device has a camera that may capture facial images and TID enrollment has been approved. If acceptable, at step 404, a POI document is submitted, such as an image or scan of an identity card or passport. The user's camera may capture such an image or scan, and, at step 406, the user may submit a selfie or other facial image. The POI document and/or selfie or other facial image may be accepted when a user captures a facial image and the facial image is of sufficient quality and include sufficient facial features and/or size/scale for proper image analysis and/or facial feature extraction.

As such, at step 408a, it is determined if an automatic verification is successful. If so, diagram 400a proceeds to a successful verification 410, where the user may be verified and a TID is established for face authentications through a face ID (e.g., one or more facial images and/or vectors encoded from values for facial features). This may be done using one or more ML models and/or AI systems for facial feature comparison and matching in different facial images (e.g., from the selfie and on the POI document). However, if not, at step 408b, it is determined if a manual verification of the POI document and selfie is successful, such as by an administrator or authoritative entity that can manually review and approve of machine facial images. If successful, diagram 400a proceeds to successful verification 410, however, if not, diagram 400a results in a failed verification 412.

If initially a face scan is not accepted, such as if a device's camera is unusable, not connected/available, or cannot capture images of a user at step 402, diagram 400a may instead proceed to step 414 where an alternative option is used. The alternative option may allow for uploading of user images and/or documents. As such, at step 416, a first POI document is submitted. Thereafter, at step 418, it is determined if face scanning is available for switching and proceeding with step 406. However, if face scan remains unavailable, diagram 400a proceeds to step 420 where a second POI document is submitted. Thereafter, at step 422, it is determined if an automatic verification of the two POI documents is successful using face matching ML models and/or systems. As such, step 422 may proceed to successful verification 410 or failed verification 412 based on facial matching and comparison results.

Referring now to diagram 400b of FIG. 4B, payment application 332 interacts with components for submitting a POI document and selfie, for example, using the processing flow shown in diagram 400a of FIG. 4A. In diagram 400b, initially, at step 18, payment application 332 launches TID webview SDK 432 for the corresponding TID processes and operations used to establish a TID for face authentication. SDK 432 may correspond to an SDK of the software and/or web application for payment application 332. Once launched at step 19, TID webview SDK 432 verifies a single sign on (SSO) link and generates an access token with an identity establishment endpoint 434. For verification and tracking of the SSO, identity establishment endpoint 434 then writes a cookie to store with TID webview SDK 432, at step 20. Further, at step 21, identity establishment endpoint 434 performs an HTTP redirect of payment application 332 to node webhost 436 for processing of security and provision of pages for selfie and POI image submissions.

At step 22, node webhost 436 generates a security context with token handler 438, and further, at step 23, provides a query level definition to server 342. This allows node webhost 436 to render a customized page for submission of images used to create a face ID for TID enrollment and face authentication. The customized page may be based on a current security context, account for TID enrollment, and other personalized features and data for payment application 332 and/or customer 440. As such, at step 25, customer 440 submits a POI document and selfie or other facial image to node webhost 436 through the personalized page. Using these images, at step 26, node webhost 436 uploads the POI document and selfie to server 342 for processing and TID enrollment.

Referring now to diagram 400c of FIG. 4D an assurance level 452 is shown with corresponding components for face authentication, where assurance level 452 is associated with an assurance that a user is authenticated, verified, and/or identified (e.g., “is who they purport to be”) when performing a cryptocurrency transaction or processing another high-risk computing activity including password recovery and the like. Assurance level 452 is shown as setup for a face authentication using a payment provider tenant in a country with a type of the assurance level for authentication. For assurance level 452, an option 454 is established for the allowance of tries or attempts for a face authentication that is provided for assurance level 452. Option 454 may therefore provide the option of a face authentication using a number of tries in a country for assurance level 452.

To process the face authentication allowed by option 454 for assurance level 452, a first requirement 456 for a liveness to be present in images and a second requirement 458 for a face match to be met are required. With both first requirement 456 and second requirement 458, a first data element group 460 for a selfie is required to meet such requirements, where second requirement 458 further requires a second data element group 462 with an existing selfie or other face ID to be used for face matching. For first data element group 460, support biometrics 464 is required for facial features in the selfie image to be identified and recognized (e.g., to determine a liveness of the user in the selfie). For second data element group 462, dependent assurance elements 466 and 468 are established and may be used for face matching using the existing selfie group for second data element group 462.

For example, dependent assurance element 466 may correspond to an enrollment selfie that was provided during enrollment, while dependent assurance element 468 may correspond to an enrollment POI document (e.g., a driver's license, passport, etc.) that was similarly provided during enrollment. Dependent assurance elements 466 and 468 may have been previously verified and/or authorized such that the corresponding user has a face match established during enrollment for a selfie with a proof of facial identity from a POI document or the like. As such, the existing selfie for second data element group 462 may correspond to a verified facial image and/or face ID that may correspond to a face biometric and verified POI document with facial identity of the user. Thus, diagram 400d shows a tree of the elements required for assurance level 452 to provide face authentication through an enrolled TID and face ID.

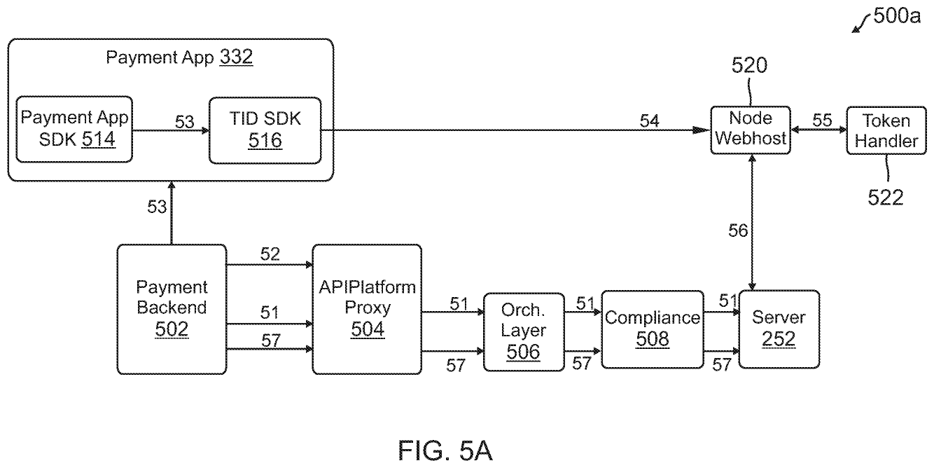

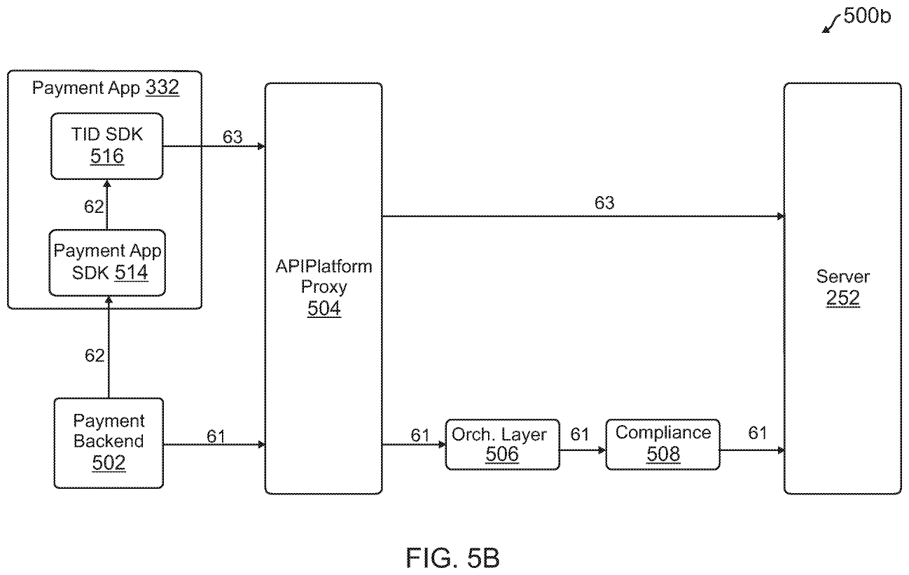

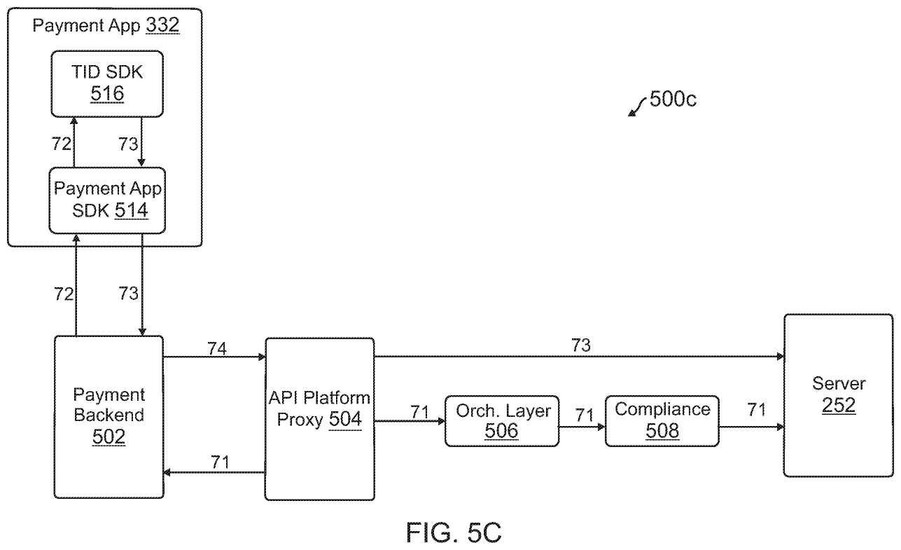

FIGS. 5A-5C are exemplary diagrams 500a-500c of processing flows for user experiences on different platforms when establishing a tethered face identifier for an account of a user, according to an embodiment. Diagrams 500a-500c include components of different experiences for a framework and orchestration layer that utilizes TIDs for authentication through face IDs and facial images, such as components used by cryptocurrency exchange platform 140 of service provider server 130 from system 100 of FIG. 1. In this regard, payment application 332 may interact with a payment backend 502 to provide the user experience when establishing and utilizing a TID for authentication for cryptocurrency transactions and the like performed through cryptocurrency exchange 142 and/or service applications 132 of service provider server 130 in system 100.

Referring now to diagram 500a of FIG. 5A, a processing flow for a webview experience via a website or web application may be seen. At step 51, a payment backend 502 may initially onboard a user utilizing payment application 332 for a cryptocurrency transfer or payment product and/or computing service of a service provider. As such, payment backend 502 may connect with an API platform proxy 504, which may interface with a orchestration layer 506, a compliance 508, and server 252. To onboard the new user with the computing service for payment backend 502, at step 52, payment backend calls API platform proxy 504 to generate a federated secure sign on (SSO) URL, which can redirect to a URL to establish a TID. This URL may be valid for a period of time and provided to payment application 332.

At step 53, payment backend 502 may then launch a payment application SDK 514 and a TID SDK 516 for face biometric capture and authentication for payment application 332. At step 54, TID SKD 516 may then establish a session with an node webhost 520 that redirects to the URL to establish a TID, where an access token to the sign on URL and TID establishment may be set in cookies for server 252 used by payment backend 502. At step 55, node webhost 520 may then call a token handler 522 in order to transfer the access token and validate establishment of a TID. Node webhost 520 and server 252 may then interact, at step 56, to collect a POI document from payment application 332 (e.g., using payment application SDK 514 and/or TOD SDK 516), as well as one or more selfies or other user images. Thereafter, at step 57, payment application 502 may then call API platform 504 for orchestration layer 506, compliance 5-8, and server 252 for provision of TID usage with cryptocurrency transactions, which may provide a result for TID enrollment and establishment for the user, account, and digital assets.

Referring now to diagram 500b of FIG. 5B, a native experience through payment application 332 is shown where a webview and website or web application is not required. Instead, the experience to establish a TID may be performed directly in the software application for payment application 332, where, at step 61, payment backend 502 interacts with API platform proxy 504, orchestration layer 506, compliance 508, and server 252 to onboard the user for a cryptocurrency transfer and/or payment product in a similar manner to step 51 in diagram 500a. Payment application 332 may then directly launch payment application SDK 514 to initialize a process to establish a TID, at step 62. Thereafter, at step 63, TID SDK 516 may then call API platform proxy 504 to upload a POI document and one or more selfies or other facial images captured via one or more user interfaces in payment application 332. API platform proxy 504 may then provide the POI document and facial image(s) to server 252 during step 63.

Referring now to diagram 500c of FIG. 5C, a native experience in payment application 332 is similarly shown to diagram 500b but where a server of payment backend 502 is used as a proxy. In a similar manner to step 51 and 61, at step 71, payment backend 502 interacts with API platform proxy 504, orchestration layer 506, compliance 508, and server 252 to onboard the user for a cryptocurrency transfer and/or payment product. Thereafter, at step 72, payment application 332 may launch payment SDK 514 with payment backend 502. At step 73, TID SDK 516 then interacts with payment SDK 514 in order to send images of a POI document and user's selfie of face to payment backed 502. Payment backend 502 then processes the images for TID establishment through calls to API platform proxy 504, which in turn calls server 252.

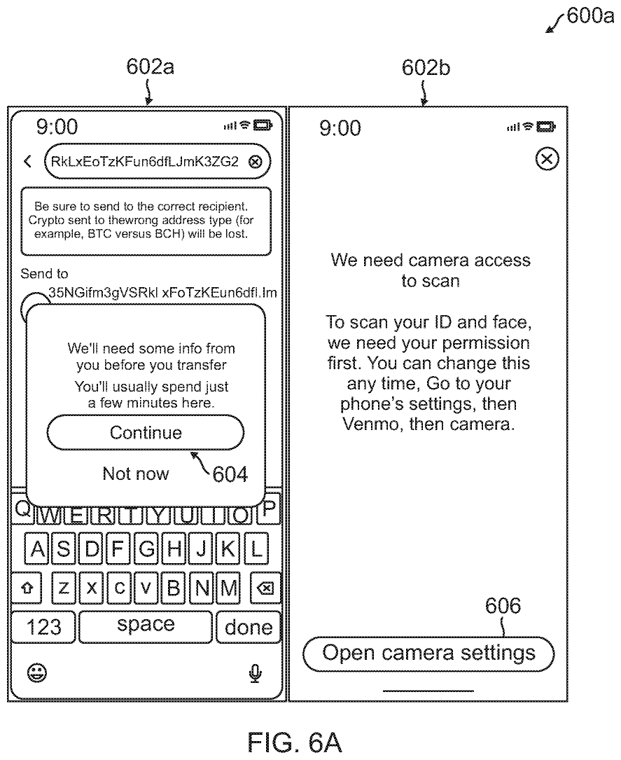

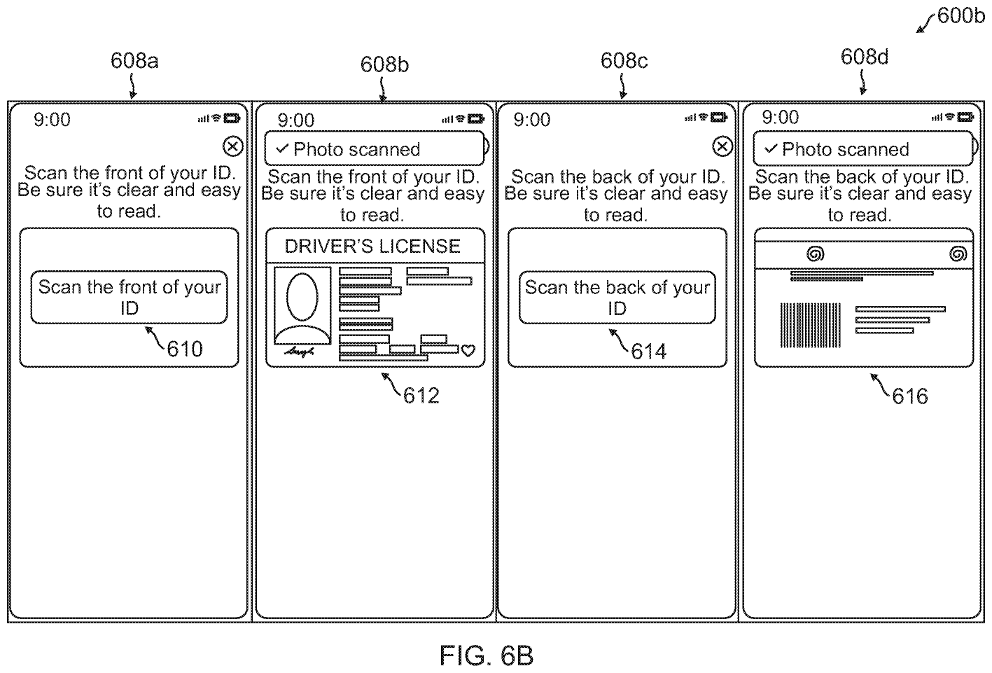

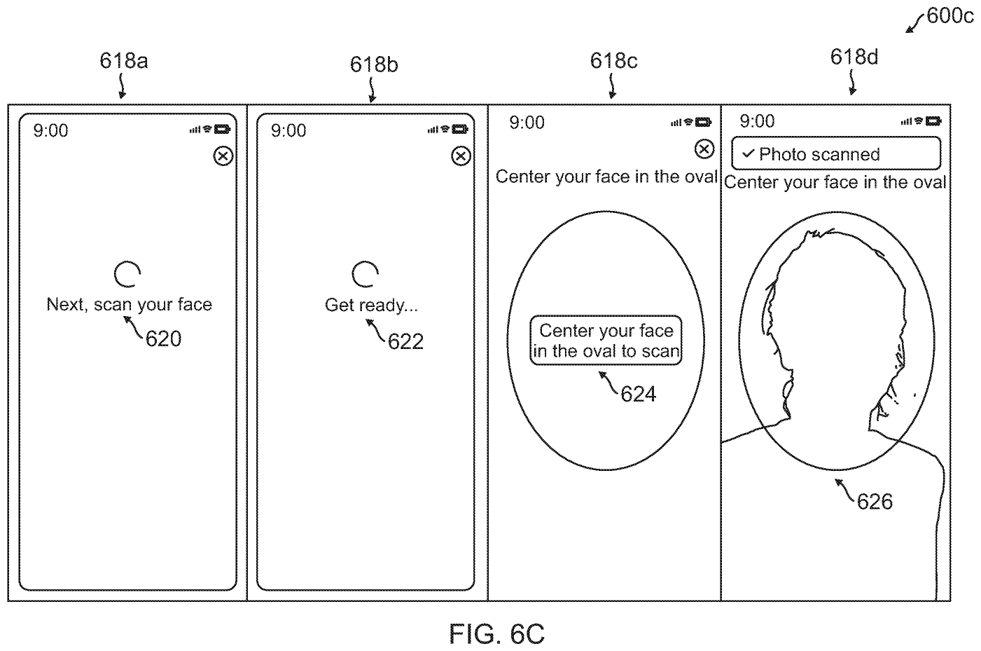

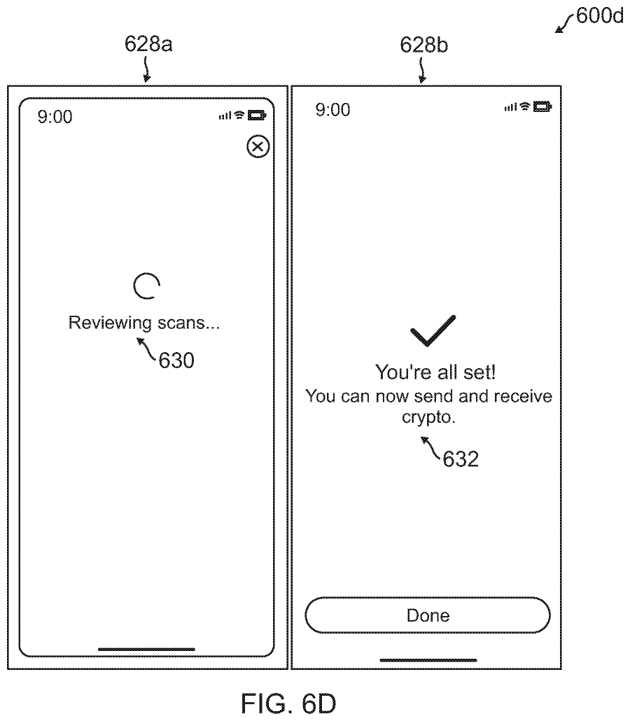

FIGS. 6A-6D are exemplary screenshots 600a-600d for establishing the face identifier tethered to a digital account for high-risk computing activities and transactions, according to an embodiment. Screenshots 600a-600d therefore include different user interfaces for an interface flow and/or transitions that may occur when a user sets up a TID using a face ID for authentication during high-risk computing activities, such as cryptocurrency transactions. As such, screenshots 600a-600d may be displayed by client device 110 based on data received from service provider server 130 discussed in reference to system 100 of FIG. 1.

Referring now to screenshots 600a of FIG. 6A, an interface 602a displays a setup request 604 initially provided when a user attempts a high-risk computing activity, such as a cryptocurrency transaction, but has not yet established a TID including a face ID used to authenticate the user and provide improved security through face biometrics during these computing activities. As such, by selecting to continue with setup request 604, interface 602a may transition to an interface 602b. In interface 602b, a camera access request 606 to access a camera of the user's device, such as the user's mobile smart phone, is requested in order to capture an image of the user's face and/or POI document(s). As such, camera access request 606 may grant a permission to the application and/or website to utilize the camera of the user's device.

Referring to screenshots 600b of FIG. 6B, interfaces 608a-608d show a process for a user to submit a POI document, specifically a driver's license in FIG. 6B but other types of POI documents having user images may also be used (e.g., ID cards, passports, and the like). As such, in interface 608a, a first ID card scan request 610 is shown where a window, box, or other alignment outline is presented and configured to assist a user in proper alignment and size capture of an image of the user's ID card or other POI document. As such, in interface 608b, a front side 612 of the user's ID card is properly aligned and captured by the camera of or connected to the device displaying interface 608b. This prompt and verification of a capture of the user's ID card allows the user to view the image capture and submit for verification. Interface 608b may then advance to interface 608c where a second ID card scan request 614 is shown and provides another alignment outline and prompt for the user to capture another image of a reverse side of the user's ID card or other POI document. The user may then use this alignment outline and prompt to capture a back side 616 of the user's ID card and view the image for submission in interface 608d.

Referring to FIG. 6C, screenshots 600c include interfaces 618a-618d where a user is prompted to provide selfies or user self-portraits and/or other facial images of the user in order to establish and/or authenticate using a TID having a face ID. As such, screenshots 600c may show a flow of user interfaces that may be used both during TID establishment to capture user facial images for a face ID, as well as during an authentication to verify the user's identity using an established TID and face ID. For example, in interface 618a, a selfie prompt 620 to scan a user's face is shown, where the user is informed to prepare for a pending image capture 622 is then shown in interface 618b while the user's device accesses and initializes a corresponding camera for use in pending image capture 622. In interface 618c, a facial image request 624 is shown with an alignment oval outline that shows a proper distance, size, and alignment of the user's head to properly capture the user's face in an image. This allows the user to move and align their device and/or head to fit within the alignment outline and other prompts. In interface 618d, a facial image 626 is then captured that includes the user's head and face likeness, which may then be provided to the service provider and face authentication system for processing.

Referring to FIG. 6D, screenshots 600d include interfaces 628a and 628b that display post-capture notifications based on image processing and facial feature comparisons for identity verification. As such, in interface 628a, a pending review notification 630, such as a spinning animation, is shown while facial image 626 is compared to another image of the user's face on the ID card or other POI document captured in screenshots 600b of FIG. 6B. This may be done in real-time or near real-time or may require some time for processing and approval. As such, pending review notification 630 may be displayed for a period of time, after which, an approval notification 632 may be displayed in interface 628b, which may be in response to an approval of the user's identity verification from the submitted images and documents. This may then allow the service provider to utilize a TID for future user authentications through a face ID and further receive facial images.

As such, the screenshots shown in FIGS. 6A-6D may be used for establishing and utilizing a TID for face authentication and identification of users during high-risk computing activities and transactions, such as cryptocurrency transactions, password recovery, and other processing flows of a service provider where it may be advantageous and/or required to implement more secure authentication (e.g., through facial images and face biometrics). This allows the interfaces and flow between interfaces (e.g., transitions) in FIGS. 6A-6D to be flexibly used for different authentications during different computing activities requested and/or processed by users (e.g., the aforementioned cryptocurrency transactions, trades, key access and/or transfer, and the like, as well as password recovery requests and identity establishment/verification during password recovery and/or reset). As such, the user may then proceed with cryptocurrency transactions, password recovery, or the like that required heightened or step-up authentication.

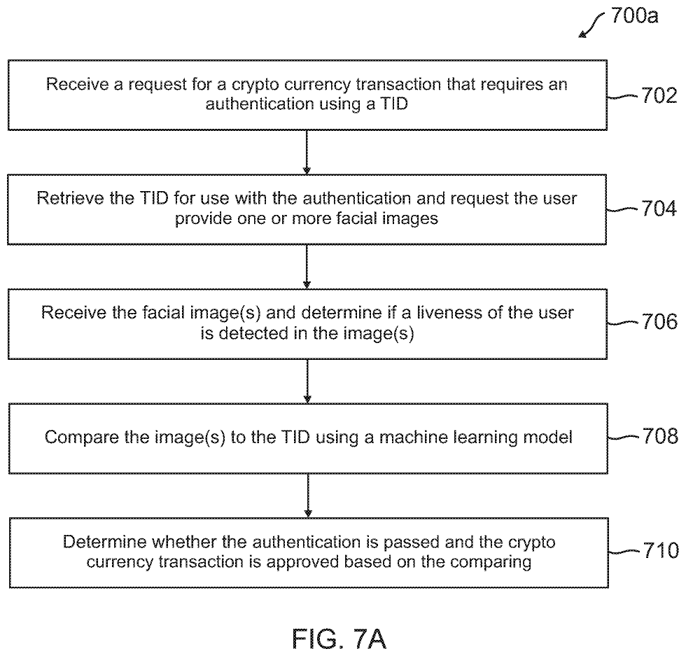

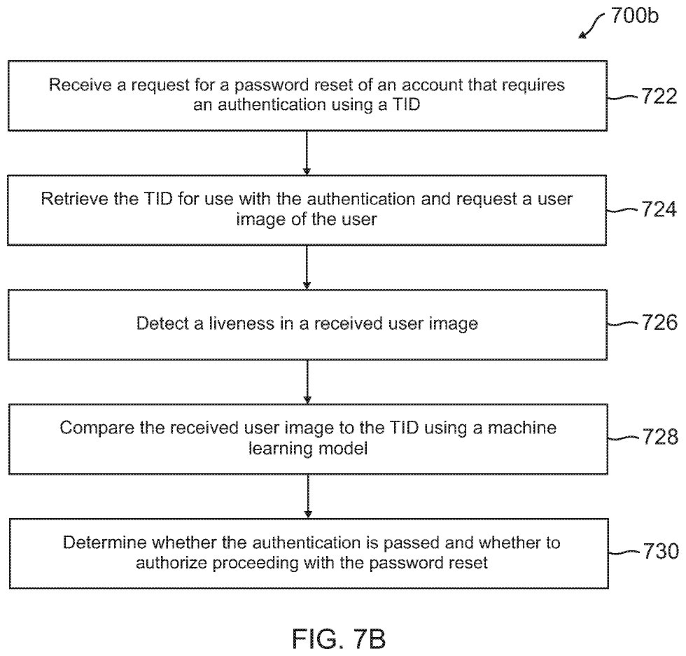

FIGS. 7A and 7B are flowcharts 700a and 700b for tethering face identifiers to digital accounts for secure authentications during high-risk computing activities, according to an embodiment. Note that one or more steps, processes, and methods described herein of flowcharts 700a and 700b may be omitted, performed in a different sequence, or combined as desired or appropriate. Further note that while flowchart 700a describes a cryptocurrency transaction and flowchart 700b described a password recovery and/or reset, other transactions, high-risk computing activities, and the like that may require and/or utilize the authentication and verifications described herein are included with similar steps, as those of ordinary skill in the art will recognize.

Referring now to flowchart 700a of FIG. 7A, at step 702 of flowchart 700a, a request for a cryptocurrency transaction that requires an authentication using a TID is received. The request may correspond to request 122 from client device 110 that may be processed by service provider server 130 using cryptocurrency exchange platform 130. For example, the request may be for a cryptocurrency transaction on cryptocurrency exchange 142 and/or using service applications 132. As such, TID operations 148 may be invoked to process the request. TID operations 148 may utilize ID assurance platform 202 to perform an authentication for the request and cryptocurrency transaction, for example, using ID assurance management 208 once the request is received.

For example, a user may enter a transaction processing flow, such as to provide a payment or transfer to another user, merchant, business, or other entity, which may require funds that the user selects to provide using an amount of cryptocurrency. In other embodiments, the cryptocurrency transaction may correspond to a purchase or sale of cryptocurrency, a trade of cryptocurrency, a transfer between digital wallets (which may be hot or cold wallets and with the same or a different user), or other exchange of cryptocurrency, such as using an online cryptocurrency exchange platform. As such, the cryptocurrency transaction may include an exchange of private keys that are used for ownership over the cryptocurrency or other digital asset (e.g., NFT). This may the designate the transaction as high-risk as the potential for theft, fraud, and/or robbery when such digital assets and keys are exchange.

At step 704, the TID is retrieved for use with the authentication and the user is requested to provide one or more facial images, for example, to authenticate using the TID. In this regard, TID operations 148 of cryptocurrency exchange platform 140 may access and retrieve one of TIDs 136 from database 134, which may be identified based on the request and corresponding user or account requesting the authentication. In this regard, ID assurance management 208 may obtain a TID in response to a request from service clients 214. For example, BMS 254 may obtain TID files and/or other data persisted to DMS 256 for use with face authentication.

The TID may be previously established by the user providing one or more facial images and one or more POI documents having the user's facial image on the document(s). The POI documents may be documents that are validated and confirmed to be issued to the user from a governing body or enforcement agency, such as a state issued driver's license, government passport, or the like. In this regard, the POI documents may be validated and the user's image on the documents compared to the submitted documents in order to create a TID that includes a face ID of the user. The face ID may correspond to one or more stored facial images, encoded vector(s) from facial features extracted from the facial image(s) of the user, or the like. Once created, the face ID may be used to generate a TID that includes the user's information, authentication information and preferences, and account identifiers that are then tethered to the user's account in order to be used for authentication during certain computing activities, such as the cryptocurrency transaction and/or other high-risk computing activities.

At step 706, the facial image(s) are received, and it is determined if a liveness of the user is detected in the image(s). With regard to ID assurance management 208, face biometrics intake 232 may provide capture SDK 234 that provides a selfie auto capture component to capture the facial image(s), as well as a liveness on gesture component that may request that the user perform an action, move, change a facial expression, or move a feature (e.g., eye, eyelids, mouth, etc.) to indicate that the user is present and able to respond to instructions. These may be verified and a facial liveness 238 may also be used with face biometrics verification 236 to further verify a user's liveness. Facial liveness 238 may utilize a face extraction and a passive liveness component to further detect liveness of a user, such as through other indications that the user is present and in the image(s) captured from small facial movements, ticks, blinking/breathing or other reflexes, and the like.

At step 708, the image(s) is/are compared to the TID using an ML model. For ID assurance management 208, face verification 236 may utilize facial comparison 240 to perform a face comparison and matching for authentication of a user. One of TIDs 136 may have a corresponding face ID, such as a facial image or encoded vector from facial features in facial image(s), which may be compared to the received images by facial comparison 240 using a face match and a face similarity check.

For example, face match of facial comparison 240 may match facial features, within a degree of similarity or difference, between images. Face similarity check of facial comparison 240 may further check a similarity of a vector from facial images, such as by processing using one or more ML models for vector encoding and vector similarity comparisons. Prior to processing for facial comparison, data preprocessing may occur. The preprocessing may correspond to general image and/or pixel cleansing, null value replacement, and the like. Thereafter, the NN, ML model, or other AI engine trained for face recognition and/or facial feature matching in different facial images and/or facial feature vectors may process input image data and the corresponding face ID for the user's TID to determine if the image(s) captured for the face authentication are of the same user.

At step 710, it is determined whether the authentication is passed and the cryptocurrency transaction is approved based on comparing the image(s) to the TID using the ML model. Based on the output by facial comparison 240, ID assurance management 208 may provide a response to service clients 214, which may correspond to approving or declining the cryptocurrency transaction requested at step 402. As such, service provider server 130 may provide a response to client device 110 for request 122, which may provide the payment or transfer of cryptocurrency between wallets and/or entities. This may include the exchange of private keys, based on an authentication performed using the TID associated with the user's account.

Referring now to flowchart 700b of FIG. 7B, at step 722 of flowchart 700b, a request for a password recovery of an account that requires an authentication using a TID is received. For example, and similar to step 702, the request may correspond to request 122 from client device 110 that may be processed by service provider server 130. However, instead of a cryptocurrency transaction and being processed on cryptocurrency exchange 142, the request may be for a password recovery and/or reset process, such as one to recover a lost or forgotten credential, establish a new credential, and/or change a credential that was or is stolen and/or misappropriated, such as when an account takeover occurs. As such, TID operations 148 may be invoked to process the request, and the user may enter a password recovery flow.

At step 724, the TID for use with the authentication is retrieved and a user image of the user is requested. TID operations 148 may access and retrieve one of TIDs 136 from database 134, which may be previously established by a user through provision of one or more selfies or other facial images and a POI document used to verify such facial images. The TID may be tethered to the account from the previous establishment and setup such that the TID availability, enrollment, and requirement for use during certain high-risk computing activities or face authentication process is established for the user and/or account. As such, the TID may be required to be processed and used to authenticate the user through submitted selfies or other facial images for authorization of the request and use of the password recovery process.

At step 726, a liveness of the user is detected in a received user image, such as the one requested at step 724. Face biometrics intake 232 may utilize capture SDK 234 to capture selfies and detect the liveness of the user in still images and/or video. Such liveness may be detected through facial movements, prompts and responses, and the like. As such, a liveness may be detected by requesting that the user perform an action or move in the selfie to indicate that the user is alive and present. Facial liveness 238 may utilize a face extraction and a passive liveness component to further detect liveness of a user.

At step 728, the received user image is compared to the TID using a machine learning model. After accessing the one of TIDs 136 and capturing a selfie or other image, facial comparison 240 may be executed, such as by TID operations 148. Comparing may therefore include processing and performing intelligent matching or correlating using an ML model and corresponding input feature for the ML model. For example, feature data for ML input features may be processed and used to compute a vector for each facial image and the like. These vectors may be compared using ML similarity checks and processing, such as a Euclidean or cosine similarity.

At step 730, it is determined whether the authentication is passed and whether to authorize proceeding with the password recovery. If the comparison from step 728 results in a sufficient similarity (e.g., meeting or exceeding a threshold similarity or comparison score or metric), facial comparison 240 of ID assurance management 208 may provide a response to service clients 214 indicating the approval of the face authentication, which may cause client device 110 and service provider server 130 to initiate and/or proceed with the processing flow for the password recovery and/or reset. The user may then reset and password or recover a password for use during login and/or user authentication.

In further embodiments, a method for providing a password reset may include receiving a request for a password reset of an account of a user from a device of the user, determining that the request requires an authentication of the user to perform the password reset, receiving at least one first facial image if the user from the device at a first time associated with the request, verifying that the at least one first facial image was captured at the first time based on a liveness of a representation of the user in the at least one first facial image, wherein the verifying is further based on a confidence score that the user is present in the at least one first facial image, comparing, using a machine learning (ML) model trained for facial image identifications of users, the at least one first facial image to a face identifier for the account, wherein the face identifier is associated with facial feature data of the user identified using the ML model, and determining whether the authentication for the password reset is approved based on the comparing.

The method may further include, either prior to the request or during the comparing, requesting a proof of identity (POI) document of the user having a user image on the POI document and at least one second facial image captured of the user at a second time of submission of the POI document, wherein the second time occurs prior to the first time, generating the face identifier based on the facial feature data extracted from the user image and the at least one second facial image, and tethering the face identifier to the account and an identity of the user across computing services for the service provider system, wherein the face identifier is required to be verified at least for the password reset performed using the computing services in association with the account or the identity. Further, the method may include, in response to the password reset being approved based on the comparing, issuing a password reset interface to the device of the user in response to the request.

In one embodiment, a method of lifting an account restriction may include receiving a request for removing of an account restriction imposed on an account of a user from a device of the user, determining that the request requires a face authentication of the user to remove the account restriction, requesting at least one first facial image of the user at a first time of the request from the device, receiving the at least one first facial image. comparing, using a machine learning (ML) model trained for facial image identifications of users, the at least one first facial image to a face identifier for the account, wherein the face identifier is associated with facial feature data of the user identified using the ML model, and determining whether the face authentication for removing the account restriction is approved based on the comparing.

In another embodiment, a method of generating an invoice may include receiving an invoice generation request for an invoice from a device of a merchant, wherein the invoice is associated with a transaction between the merchant and a user, determining that the request requires a face authentication of the user to generate the invoice based on the invoice generation request, requesting at least one first facial image of the user at a first time of the request from the device, receiving the at least one first facial image, comparing, using a machine learning (ML) model trained for facial image identifications of users, the at least one first facial image to a face identifier for the account, wherein the face identifier is associated with facial feature data of the user identified using the ML model, and determining whether the face authentication for generating the invoice based on the invoice generation request is approved based on the comparing.

In a further embodiment, a method of establishing a trust relationship may include receiving a request to establish a trust relationship for a billing agreement between a buyer and a merchant, wherein the trust relationship establishes the buyer as a trusted buyer of the merchant requiring reduced authentication during future purchases, determining that the request requires a face authentication of the user to establish the trust relationship for the buyer based on the billing agreement, requesting at least one first facial image of the user at a first time of the request from the device, receiving the at least one first facial image, comparing, using a machine learning (ML) model trained for facial image identifications of users, the at least one first facial image to a face identifier for the account, wherein the face identifier is associated with facial feature data of the user identified using the ML model, and determining whether the face authentication for establishing the trust relationship based on the billing agreement is approved based on the comparing.

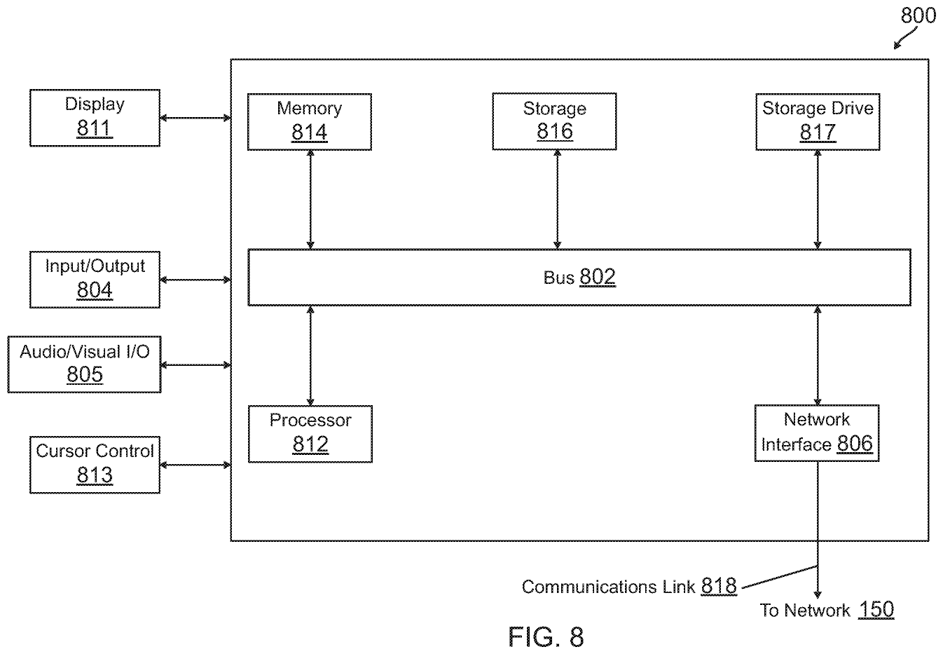

FIG. 8 is a block diagram of a computer system 800 suitable for implementing one or more components in FIG. 1, according to an embodiment. For example, computer system 800 may correspond to client device 110 and/or service provider server 130, which may be used for executing steps 702-730 in flowcharts 700a and 700b of FIGS. 7A and 7B. In various embodiments, computer system 800 may comprise a personal computing device (e.g., smart phone, a computing tablet, a personal computer, laptop, a wearable computing device such as glasses or a watch, Bluetooth device, key FOB, badge, etc.) capable of communicating with the network. A service provider may utilize a network computing device corresponding to computer system 800 (e.g., a network server) capable of communicating with the network. It should be appreciated that each of the devices utilized by users and service providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, and/or moving one or more images, etc., and sends a corresponding signal to bus 802. I/O component 804 may also include an output component, such as a display 811 and a cursor control 813 (such as a keyboard, keypad, mouse, etc.). An optional audio input/output component 805 may also be included to allow a user to use voice for inputting information by converting audio signals. Audio I/O component 805 may allow the user to hear audio. A transceiver or network interface 806 transmits and receives signals between computer system 800 and other devices, such as another communication device, service device, or a service provider server via network 150. In one embodiment, the transmission is wireless, although other transmission mediums and methods may also be suitable. One or more processors 812, which can be a micro-controller, digital signal processor (DSP), or other processing component, processes these various signals, such as for display on computer system 800 or transmission to other devices via a communication link 818. Processor(s) 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor(s) 812 and other components by executing one or more sequences of instructions contained in system memory component 814. Logic may be encoded in a computer readable medium, which may refer to any medium that participates in providing instructions to processor(s) 812 for execution. Such a medium may take many forms, including but not limited to, non-volatile media, volatile media, and transmission media. In various embodiments, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
receiving a request for a cryptocurrency transaction from a device of a user;
determining that the request requires an authentication of the user to process the cryptocurrency transaction;
receiving at least one first facial image of the user from the device based on the authentication required to process the cryptocurrency transaction;
detecting that the at least one first facial image indicates a liveness of the user when captured, wherein the liveness corresponds to a confidence score that the user was present in the at least one first facial image when captured;
comparing, using a machine learning (ML) model trained for facial feature data comparisons in different user images, the at least one first facial image to a face identifier for an account of the user, wherein the face identifier is associated with first facial feature data of the user determined using the ML model; and
determining whether the authentication for the cryptocurrency transaction is approved based on the comparing.

2. The service provider system of claim 1, wherein, prior to the receiving the request, the operations further comprise:
generating the face identifier for the account using a user image on a proof of identity (POI) document of the user and at least one second facial image captured of the user when the POI document is submitted; and
tethering the face identifier to the account and an identity of the user across computing services for the service provider system, wherein the face identifier is required to be verified at least for cryptocurrency transactions performed using the computing services in association with the account or the identity.

3. The service provider system 1, wherein the comparing comprises:
determining the first facial feature data for the face identifier;
extracting, using the ML model, second facial feature data from the at least one first facial image; and
computing a similarity score of the first facial feature data to the second facial feature data.

4. The service provider system 3, wherein the first facial feature data corresponds to a first vector computed using ML features for the ML model that correspond to facial features in different user images.

5. The service provider system of claim 1, wherein the operations are performed using an orchestration layer that enables service integrations with a cryptocurrency transaction service for the cryptocurrency transaction and other computing services of the service provider system, and wherein the orchestration layer tethers the face identifier to an identity of the user across the cryptocurrency transaction and the other computing services of the service provider system.

6. The service provider system 1, wherein, in response to the authentication being approved based on the comparing, the operations further comprise:
processing the cryptocurrency transaction based on the request.

7. The service provider system 1, wherein, prior to the detecting, the operations further comprise:
requesting that the user perform a face movement that indicates the liveness of the user when capturing the at least one first facial image; and
computing the confidence score based on a response to receiving the face movement.

8. The service provider system 1, wherein the cryptocurrency transaction requires an access to a private key associated with cryptocurrency available to the account, and wherein the operations further comprise:
providing the access to the private key based on determining that the authentication is approved based on the comparing.

9. A method comprising:
receiving a request to establish a face biometric identifier with an account of a user utilized for cryptocurrency transactions, wherein the account is associated with a balance of a cryptocurrency available for use with the cryptocurrency transactions;
requesting a proof of identity (POI) document for the user and at least one facial image of the user;
receiving the POI document from the user;
verifying the POI document based on at least one data field found on the POI document and a first machine learning (ML) model trained for identity document verifications based on a plurality of data fields on a plurality of POI document types;
receiving the at least one facial image of the user;
detecting whether the at least one facial image indicates a liveness of the user, wherein the liveness corresponds to a confidence score that the user is present in the at least one facial image;
comparing a user image on the POI document to the at least one facial image using a second ML model trained for facial feature data comparisons in different user images;
generating the face biometric identifier based on the comparing and the user image being within a threshold comparison score for a verification of the user; and
enabling use of the face biometric identifier during processing of the cryptocurrency transactions for the account, wherein the face biometric identifier is tethered to an identity of the user with a service provider system.

10. The method of claim 9, wherein the comparing the user image on the POI document to the at least one facial image comprises:
extracting, using the second ML model, first facial feature data of the user from the user image on the POI document;
extracting, using the second ML model, the at least one facial image of the user for second facial feature data;
computing, using the second ML model, a first vector for the first facial feature data and a second vector for the second facial feature data; and
comparing, using the second ML model, the first facial feature data to the second facial feature, wherein the comparing uses the threshold comparison score for a determination of the verification of the user.

11. The method of claim 9, wherein the verifying, detecting, comparing, and generating are performed using an orchestration layer of the service provider system, and wherein the orchestration layer is connected with a plurality of computing services of the service provider system including a cryptocurrency transaction service for the cryptocurrency transactions.

12. The method of claim 9, further comprising:
receiving a request to process a cryptocurrency transaction;
determining that the face biometric identifier is required for the cryptocurrency transaction; and
requesting at least one further facial image to authenticate the user for the request using the cryptocurrency transaction.

13. The method of claim 12, further comprising:
receiving the at least one further facial image;
comparing the at least one further facial image to the face biometric identifier using the second ML model; and
determining whether to approve the request based on the comparing the at least one further facial image to the face biometric identifier.

14. The method of claim 9, wherein the face biometric identifier is associated with an assurance level provided to the account for authentications during the cryptocurrency transactions.

15. The method of claim 9, wherein the account includes a tethered identifier linked to the identity of the user and including the face biometric identifier.

16. A non-transitory machine-readable medium having stored thereon machine-readable instructions executable to cause a machine to perform operations comprising:
receiving a request for an authentication of a user to process a cryptocurrency transaction, wherein the request includes a first facial image of the user from a device of the user;
detecting that the first facial image meets or exceeds a threshold score indicating a liveness of the user in the first facial image when captured, wherein the liveness is associated with a determination that the user was physically present in a scene by the first facial image;
comparing, using a machine learning (ML) model trained for facial feature data comparisons in different user images, the first facial image to a face identifier for an account of the user, wherein the face identifier is associated with first facial feature data of the user that was previously determined and verified; and
authenticating the request for the cryptocurrency transaction based on the comparing.

17. The non-transitory machine-readable medium of claim 16, wherein the operations further comprise:
accessing a tethered identifier for the account that includes the facial feature data usable for the authentication of the user,
wherein the comparing is performed responsive to the accessing.

18. The non-transitory machine-readable medium of claim 16, wherein the request for the authentication is received by an orchestration layer for an identity-as-a-service platform of a service provider processing the cryptocurrency transaction.

19. The non-transitory machine-readable medium of claim 18, wherein the orchestration layer is connected to a plurality of clients for a plurality of computing services of the service provider.

20. The non-transitory machine-readable medium of claim 16, wherein the operations further comprise:
processing the cryptocurrency transaction based on the authentication and one or more cryptocurrencies owned by the user.
